(19) United States
(12) Patent Application Publication
(10) Pub. No.: US 2011/0020572 A1
(43) Pub. Date: Jan. 27, 2011

(54) STRUCTURAL ORGANOSHEET-COMPONENT

(75) Inventors: Thomas MALEK, Pulhelm (DE); Julian HASPEL, Koln (DE); Ulrich DAJEK, Leverkusen (DE); Ralf ZIMNOL, Overath (DE); Wolfgang WAMBACH, Koln (DE)

Correspondence Address: GERSTENZANG, WILLIAM C.;NORRIS MCLAUGHLIN & MARCUS, PA, 875 THIRD AVE, 8TH FLOOR, NEW YORK, NY, 10022, US

(73) Assignee: LANXESS Deutschland GmbH, Leverkusen (DE)

(21) Appl. No.: 12/839,926

(22) Filed: Jul. 20, 2010

(30) Foreign Application Priority Data
Jul. 25, 2009 (DE) 10 2009 034 767.4

(51) Int. Cl. B32B 27/08; B32B 3/24; B32B 27/36; B32B 27/28; C08L 67/07; C08L 67/02; C08L 69/00

(52) U.S. Cl. 428/35.7; 428/201; 428/412; 428/480; 525/55; 525/418; 525/462

(57) ABSTRACT

The present invention relates to structural organosheet-components of hybrid design composed of an organosheet which is reinforced by means of thermoplastics and which is suitable for the transmission of high mechanical loads, where particular flow aids are added to the thermoplastic in order to improve its physical properties.

The present invention relates to structural organosheet-components of hybrid design composed of an organosheet which is reinforced by means of thermoplastics and which is suitable for the transmission of high mechanical loads, where particular flow aids are added to the thermoplastic in order to improve its physical properties.

Structural organosheet-components of this type, appropriately shaped, are used for parts of ships, parts of aircraft, and parts of vehicles, and in load-bearing elements of office machinery, of household machinery, or of other machinery, or in design elements for decorative purposes or the like.

### BACKGROUND OF THE INVENTION

DE 20 2006 019 341 U1 discloses structural organosheet-components with a plastics insert that stiffens structure and that has been subjected to an in-mold-coating or, respectively, an at least partial overmolding process, using a thermoplastic material, in such a way that the plastics insert enters into coherent bonding with the thermoplastic material.

Structural organosheet-components can be used in many sectors. By way of example, they are particularly used in motor vehicle construction, since it is possible to provide lightweight structural components permitting further reduction of weight, in comparison with the use of metal, without any loss of necessary torsional stiffness. The omission of steel inserts also eliminates the risk of corrosion and, once organosheet has left the injection-molding process, its surface is never damaged by corrosion.

A significant aspect of structural organosheet-components is that the plastics insert that stiffens the structure enters into a coherent bond with the thermoplastic material. The coherent bond is achieved by way of the process parameters, in particular melt temperature and mold temperature, and also pressure. Another process parameter that may be mentioned is the thickness of the insert, i.e. of the plastics sheet or the organosheet. The necessary or desired torsional stiffness is achieved via the shaping of the structural component, the mold used for the in-mold-coating or overmolding process, for example with reinforcement ribs, and/or the thicknesses of material, which can also vary over the length of the structural component.

The materials used, namely the structure-reinforcing plastics insert/the organosheet and the thermoplastic material, enter into coherent bonding with one another without use of jointing means, and adhesion promoters, or linkage points designed into the system. The coherent bond is based inter alia on identical in-mold-coating material and, respectively, matrix material of the reinforcing insert/the organosheet. Any thermoplastic material can be used for the in-mold-coating or overmolding process and for the matrix material of the plastics insert/the organosheet.

There are further application sectors of structural organosheet-components wherever there is a need for structures which can bear load but which have minimum weight. These sectors are not only automobile construction (tailgates, roof modules, door modules, assembly supports, front-end structures and rear-end structures, dashboards, etc.) but also aircraft construction, commercial-vehicle construction, and everyday items, for example baby strollers, ski boots, skateboards, sports shoes, and the like.

However, a disadvantage of the structural organosheet-components of the prior art is that injection of the material onto the surface of the plastics insert/the organosheet can cause fiber offset therein. Furthermore, it is not always possible to ensure an improved level of adhesion between the thermoplastic material to be injected and the plastics insert, particularly if the plastics insert/the organosheet is a thick sheet, or the thermoplastic to be injected has high content of fillers, in particular glass fibers.

For the purposes of the present invention, high content of fillers means from 45 to 90% by weight of filler, preferably from 50 to 80% by weight of filler, particularly preferably from 60 to 75% by weight of filler, based on 100% by weight of thermoplastic to be injected.

The obj ect of the present invention therefore consisted in providing structural organosheet-components in which the plastics insert/organosheet can be designed thinner in respect of a further weight reduction, without any occurrence of fiber offset in the thin inserts during the injection-molding procedure, and also to achieve, as far as possible improved adhesion between the plastics insert/organosheet and the thermoplastic to be injected.

### SUMMARY OF THE INVENTION

The object is achieved via structural organosheet-components, and these are therefore provided by the present invention, and are composed of polymer-overmolded organosheet, wherein the backing material used comprises polymer molding compositions comprising
A) from 99.99 to 10 parts by weight, more preferably from 99.5 to 40 parts by weight, particularly preferably from 99.0 to 55 parts by weight, of thermoplastic, and
B) from 0.01 to 50 parts by weight, preferably from 0.25 to 20 parts by weight, particularly preferably from 1.0 to 15 parts by weight, of a flow improver, where the flow improver used comprises at least one component from the group of B1), B2), B3), and B4), in which
B1) is a copolymer composed of at least one olefin, preferably a-olefin, and of at least one methacrylate or acrylate of an aliphatic alcohol, preferably of an aliphatic alcohol having from 1 to 30 carbon atoms, where the MFI is not less than 100 g/10 min, and where the MFI (melt flow index) is measured or determined at 190° C., using a test weight of 2.16 kg,
B2) is a highly branched or hyperbranched polycarbonate with an OH number of from 1 to 600 mg KOH/g of polycarbonate (to DIN 53240, Part 2),
B3) is a highly branched or hyperbranched polyester of AₓB_{y} type, where x is at least 1.1 and y is at least 2.1, and
B4) is a low-molecular-weight polyalkylene glycol ester (PAGE) of the general formula (I)

R—COO—(Z—O)ₙOC—R (I)
in which
R is a branched or straight-chain alkyl group having from 1 to 20 carbon atoms,
Z is a branched or straight-chain C₂-C₁₅-alkylene group, and
n is a whole number from 2 to 20,

or wherein, irrespective of the use of a component B), the thermoplastics used comprise polyamides having macromolecular chains with star-shaped structure and having linear macromolecular chains.

In one preferred embodiment, the secure interlock bond between molded-on thermoplastic and the organosheet can additionally be achieved by way of discrete connection sites, namely by way of perforations in the parent body, where the thermoplastic extends through these and across the areas of the perforations, thus additionally reinforcing the intrinsically secure interlock bond.

For clarification, it should be noted that the scope of the invention encompasses any desired combination of all of the definitions and parameters listed in general terms or in preferred ranges.

### DETAILED DESCRIPTION OF THE INVENTION

The organosheets to be used for the structural organosheet-component of the invention are prior art. An organosheet is a semifinished product which initially takes the form of a sheet and is composed of fiber-reinforced thermoplastic. By way of example, organosheets to be used in the invention are described in DE 10 2006 013 684 A1 or in DE 10 2004 060 009 A1, as also is a process for the production thereof.

A semifinished product/organosheet to be used in the invention is composed of a thermoplastic matrix reinforced by a woven fabric, or by a nonwoven scrim, or by a unidirectional fabric.

Preferred unidirectional fabrics are composed of glass, preferably glass fibers, carbon, aramid, or of these constituents in the form of a mixture. However, in alternative embodiments it is also possible to use braids composed of metal, preferably of steel.

The invention particularly preferably uses woven fiber fabrics or fiber felts composed of glass fibers, aramid fibers, or carbon fibers, surrounded by a matrix composed of thermoplastic.

The semifinished product/organosheet has been completely impregnated with said thermoplastic and consolidated, i.e. the fibers have by this stage been completely wetted by plastic, and there is no air in the material, and the semifinished product is merely subjected to a forming process via heating and subsequent pressing within short cycle times to give three-dimensional components. The material does not undergo any chemical conversion during the forming process.

The orientation of the fiber braid can be unidirectional or bidirectional, with any desired angle between the two directions, preferably a right angle.

In one preferred embodiment, the fabrics are (highly) oriented (stretched), and embedded into the plastics matrix using a high degree of orientation, and using high fiber content.

This fiber-reinforced plastics matrix, together with a backing material, in essence provides the mechanical properties required, and has a thin functional layer which provides additional functions, such as resistance to corrosion or to solvents, resistance to temperature change, suitability for use with foods, suitability for, or approval for, use with drinking water, and the like.

It is preferable that, when the functional layer is applied by way of a foil or an organosheet, the foil or the organosheet is first subjected to a preforming process via thermoforming, for example by means of air pressure, before being arranged in a mold, preferably an injection mold, so that the backing material can be applied by casting, in particular injection molding, on one side of the preformed foil or of the organosheet, i.e. on the reverse side.

The organosheets are heated by means of infrared radiation for the three-dimensional forming process and, by way of example, are subjected to forming by means of membrane processes or by using rubber molds or metal molds.

The layer thickness of the foil or of the organosheet here is preferably from a few tenths of a millimeter up to one millimeter.

In order to improve the adhesion between the foil or the organosheet and the backing material, an adhesion-promoter layer or primer layer can be applied on the organosheet or on the foil, i.e. on the reverse side of the foil, before the foil or organosheet undergoes the film formation or in-mold-coating process. There can also be an alternative or additional surface treatment of the foil or of the organosheet, for example a plasma treatment, a corona treatment, or the like. The interface between functional layer and backing material can be prepared in order to improve bond strength. One possibility here is that the surface of the foil or of the organosheet can also have a surface pattern or a surface structure to improve the adhesion of the backing material, and these can by way of example be introduced during the shaping process. The backing material is the improved-flow polymer molding composition to be used in the invention.

Functional materials that can be used for the production of the organosheet are crosslinked plastics, thermosets, protective coatings, or thermoplastics, preferably polyamides, in particular aromatic polyamides, such as polyphthalamide, polysulfone PSU, polyphenylene sulfide PPS, polyphthalamides (PPA), poly(arylene ether sulfones), such as PES, or PPSU, or PEI, polyesters, such as polybutylene terephthalate (PBT), or polyethylene terephthalate (PET), polypropylene (PP), polyethylene (PE), or polyimides (PI). Further embodiments are found in DE 10 2006 013 684 A1.

The thicknesses of organosheets to be produced in that way and to be used in the invention are preferably from 0.3 to 6 mm, preferably from 0.5 to 3 mm.

A structural organosheet-component of the invention, to be produced from these organosheets, can take the form of a semifinished sheet or can take the form of a molded structural component, for example for bodyshells, or else for other applications which require structures that have torsional stiffness but low weight. In one preferred embodiment, it has the shape of a shell.

The coherent bond resulting from the in-mold-coating process or overmolding process, between the improved-flow thermoplastic backing material and the plastics insert, i.e. the organosheet, that stiffens the structure can, in the invention, be present over the entire component or else only in sections. For the production of a structural organosheet-component of the invention, a plastics sheet/an organosheet is first provided, and comprises a reinforcing material, where the matrix material thereof is composed of plastic. As described above, the reinforcing material can preferably be glass fiber. In a subsequent step, the plastics sheet is subjected to an in-mold-coating process or overmolding process, and the coherent bond is produced by setting a suitable temperature and/or a suitable pressure. Between these two process steps it is also possible, if appropriate, to introduce a step in which a molding is produced from the plastics sheet or the organosheet. As an alternative, shaping and an overmolding or in-mold-coating process can take place in one operation, by placing the plastics sheet or the organosheet with reinforcing material in a mold and, prior to or after the shaping procedure, adding the improved-flow thermoplastic backing material which comprises components A) and B) and which serves for the overmolding or in-mold-coating process.

The combination of organosheet and improved-flow polymer/thermoplastic as backing material permits minimization, or indeed complete replacement, of metallic reinforcement in lightweight components. The coherent bond of the invention, between the plastics insert/organosheets that stiffen the structure and the backing material, markedly improves mechanical properties and therefore also improves the strength of the resultant structural component. As indicated above, the plastics insert that is to be subject to overmolding can be concomitantly molded in a single operation in the injection mold, and this is attended by a considerable cost advantage since the production of a semifinished product can be omitted.

The reduced amount of steel used, or the complete replacement of steel, reduces or, respectively, eliminates the risk of corrosion, and a further reduction of the weight of the lightweight component is achieved. In the event of complete replacement of steel, furthermore, disposal of the lightweight component installed in the motor vehicle becomes easier in compliance with regulations applicable to used vehicles. The plastics insert, i.e. the organosheet, reduces the wear caused to molds, compared to steel, during the process of shaping for the purposes of the present invention.

Surprisingly, the use of improved-flow thermoplastics in the invention also markedly reduces fiber offset in the organosheet during the in-mold-sheet-coating process, and achieves improved adhesion between organosheet and backing material, even if the thermoplastic to be injected has high filler content.

An advantage of the use of improved-flow thermoplastic molding compositions in combination with organosheets is apparent at locations where fiber offset is actually intended, namely locally at regions where the melt has to penetrate through the organosheet, e.g. at injection sites, where these (must) lie on the opposite side of the component, or else at sites which intentionally have a cavity on the opposite side within the mold, in order to enforce passage of the material and thus to achieve ideal bonding to the organosheet.

Surprisingly, the use of improved-flow thermoplastic molding compositions in combination with organosheets leads to improved adhesion of the molding composition to the organosheet when comparison is made with adhesion to a steel sheet. As revealed by the experimental work in the context of the present invention, injection of the melt of the thermoplastic molding composition into the mold and onto the organosheet can be faster. The temperature of the melt on encountering the organosheet is therefore higher than if thermoplastics without improved flow were used. When the melt encounters the organosheet, there is improved transmission to the latter of the injection pressure and also, at a somewhat later juncture, of the hold pressure, and fusion to the surface of the organosheet is thus optimized.

The thermoplastic material to be used as component A) in the backing material preferably comprises semicrystalline thermoplastic polymers (thermoplastics) selected from the group of the polyamides, vinylaromatic polymers, ASA polymers, ABS polymers, SAN polymers, POM, PPE, polyarylene ether sulfones, polypropylene (PP), and blends of these. It is particularly preferable to use polyamides, polyesters, polypropylene, and polycarbonates, or blends comprising polyamide, polyester, or polycarbonate, as substantive constituent.

Polyamides to be used with particular preference as component A) in the invention are semicrystalline polyamides, where these can be produced from diamines and dicarboxylic acids, and/or lactams having at least 5 ring members, or from corresponding amino acids. Starting materials that can be used for this purpose are aliphatic and/or aromatic dicarboxylic acids, such as adipic acid, 2,2,4- and 2,4,4-trimethyladipic acid, azelaic acid, sebacic acid, isophthalic acid, terephthalic acid, aliphatic and/or aromatic diamines, e.g. tetramethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bisaminomethylcyclohexane, phenylenediamines, xylylenediamines, aminocarboxylic acids, such as aminocaproic acid, and the corresponding lactams. The materials include copolyamides composed of a plurality of the monomers mentioned.

Polyamides preferred in the invention are those produced from caprolactams, very particularly preferably from ε-caprolactam, and also most of the compounded materials that are based on PA6, on PA66, and on other aliphatic and/or aromatic polyamides and, respectively, copolyamides, and that have from 3 to 11 methylene groups in the polymer chain for each polyamide group.

Semicrystalline polyamides to be used as component A) in the invention can also be used in a mixture with other polyamides and/or with other polymers.

Conventional additives, e.g. mold-release agents, stabilizers, and/or flow aids, can be admixed within the melt of the polyamides, or can be applied to the surface of these.

In one preferred embodiment, polyamides are used which contain macromolecular chains of star-shaped structure and linear macromolecular chains. In an alternatively preferred embodiment of the present invention, these polyamides, which have improved flow simply by virtue of their structure, can be used irrespective of the use of component B). These polyamides which have improved flow by virtue of their structure are obtained by polymerizing, in accordance with DE 699 09 629 T2, (U.S. Pat. No. 6,525,166 B1), a mixture of monomers which encompasses at least

a) monomers of the general formula (II) R₁-(-D-Z)ₘ,

b) monomers of the general formula (IIIa) X—R₂—Y and

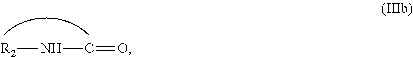

c) monomers of the general formula (IV) Z—R₃—Z, in which

R₁ is a linear or cyclic, aromatic or aliphatic carbon radical which encompasses at least two carbon atoms and can encompass heteroatoms,

D is a covalent bond or an aliphatic hydrocarbon radical having from 1 to 6 carbon atoms,

Z is a primary amine radical or a carboxy group,

R₂ and R₃ are identical or different and are aliphatic, cycloaliphatic, or aromatic, substituted or unsubstituted hydrocarbon radicals which encompass from 2 to 20 carbon atoms and can encompass heteroatoms, and

Y is a primary amine radical if X is a carbonyl radical, or Y is a carbonyl radical if X is a primary amine radical, where m is a whole number from 3 to 8.

The molar concentration of the monomers of the formula (II) in the monomer mixture is preferably from 0.1% to 2%, and that of the monomers of the formula (IV) is preferably from 0.1% to 2%, while the balance of 100% corresponds to the monomers of the general formulae (IIIa) and (IIIb).

Polyesters which are also to be used as particularly preferred component A) in the invention are polyesters based on aromatic dicarboxylic acids and on an aliphatic or aromatic dihydroxy compound.

A first group of preferred polyesters is that of polyalkylene terephthalates, in particular those having from 2 to 10 carbon atoms in the alcohol moiety.

Polyalkylene terephthalates of this type are described in the literature. Their main chain comprises an aromatic ring which derives from the aromatic dicarboxylic acid. There may also be substitution in the aromatic ring, e.g. by halogen, such as chlorine or bromine, or by C₁-C₄-alkyl groups, such as methyl, ethyl, iso- or n-propyl, or n-, iso- or tert-butyl groups.

These polyalkylene terephthalates may be prepared by reacting aromatic dicarboxylic acids, or their esters or other ester-forming derivatives, with aliphatic dihydroxy compounds in a known manner.

Preferred dicarboxylic acids that may be mentioned are 2,6-naphthalenedicarboxylic acid, terephthalic acid and isophthalic acid, and mixtures of these. Up to 30 mol %, preferably not more than 10 mol %, of the aromatic dicarboxylic acids may be replaced by aliphatic or cycloaliphatic dicarboxylic acids, such as adipic acid, azelaic acid, sebacic acid, dodecanedioic acids and cyclohexanedicarboxylic acids.

Among the aliphatic dihydroxy compounds, preference is given to diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol, and mixtures of these.

Polyesters of component A) whose use is very particularly preferred are polyalkylene terephthalates derived from alkanediols having from 2 to 6 carbon atoms. Among these, particular preference is given to polyethylene terephthalate, polypropylene terephthalate and polybutylene terephthalate, and mixtures of these. Preference is also given to PET and/or PBT which comprise, as other monomer units, up to 1% by weight, preferably up to 0.75% by weight, of 1,6-hexanediol and/or 2-methyl-1,5-pentanediol.

The viscosity number of polyesters whose use is preferred according to the invention as component A) is generally in the range from 50 to 220, preferably from 8 to 160 (measured in 0.5% strength by weight solution in a phenol/o-dichlorobenzene mixture in a ratio by weight of 1:1 at 25° C.) in accordance with ISO 1628.

Particular preference is given to polyesters whose carboxy end group content is up to 100 meq/kg of polyester, preferably up to 50 meq/kg of polyester and in particular up to 40 meq/kg of polyester. Polyesters of this type may be prepared, for example, by the process of DE-A 44 01 055. The carboxy end group content is usually determined by titration methods (e.g. potentiometry).

If polyester mixtures are used as component A), the molding compositions comprise a mixture composed of polyesters which differ from PBT, an example being polyethylene terephthalate (PET). The content by way of example of the polyethylene terephthalate is preferably up to 50% by weight in the mixture, in particular from 10 to 35% by weight, based on 100% by weight of A).

Other materials that are used advantageously as component A) in the improved-flow molding compositions are recyclates, for example PA recyclates or PET recyclates (also termed scrap PET), if appropriate, in a mixture with polyalkylene terephthalates, such as PBT.

Recyclates are generally:
1) those known as post-industrial recyclates: these are production wastes during polycondensation or during processing, e.g. sprues from injection molding, start-up material from injection molding or extrusion, or edge trims from extruded sheets or foils.
2) post-consumer recyclates: these are plastic items which are collected and treated after utilization by the end consumer. Blow-molded PET bottles for mineral water, soft drinks and juices are easily the predominant items in terms of quantity.

Both types of recyclate may be used either as ground material or in the form of pellets. In the latter case, the crude recyclates are separated and purified and then melted and pelletized using an extruder. This usually facilitates handling and free flow, and metering for further steps in processing.

The recyclates used may be either pelletized or in the form of regrind. The edge length should not be more than 10 mm, preferably less than 8 mm.

Because polyesters undergo hydrolytic cleavage during processing (due to traces of moisture) it is advisable to predry the recyclate. The residual moisture content after drying is preferably <0.2%, in particular <0.05%.

Another group that may be mentioned of polyesters whose use is preferred for component A) is that of fully aromatic polyesters derived from aromatic dicarboxylic acids and aromatic dihydroxy compounds.

Suitable aromatic dicarboxylic acids are the compounds previously mentioned for the polyalkylene terephthalates. The mixtures preferably used are composed of from 5 to 100 mol % of isophthalic acid and from 0 to 95 mol % of terephthalic acid, in particular from about 50 to about 80% of terephthalic acid and from 20 to about 50% of isophthalic acid.

The aromatic dihydroxy compounds preferably have the general formula (V)

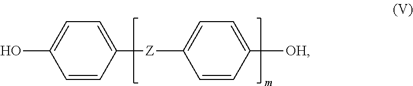

where
Z is an alkylene or cycloalkylene group having up to 8 carbon atoms, an arylene group having up to 12 carbon atoms, a carbonyl group, a sulfonyl group, an oxygen or sulfur atom, or a chemical bond, and where
m is from 0 to 2.

The phenylene groups of the compounds may also have substitution by C₁-C₆-alkyl or -alkoxy groups and fluorine, chlorine or bromine.

Examples of parent compounds for these compounds are dihydroxybiphenyl, di(hydroxyphenyl)alkane, di(hydroxyphenyl)cycloalkane, di(hydroxyphenyl)sulfide, di(hydroxyphenyl)ether, di(hydroxyphenyl)ketone, di(hydroxyphenyl)sulfoxide, α,α′-di(hydroxyphenyl)dialkylbenzene, di(hydroxyphenyl)sulfone, di(hydroxybenzene)benzene, resorcinol, and hydroquinone, and also the ring-alkylated and ring-halogenated derivatives of these.

Among these, preference is given to 4,4′-dihydroxybiphenyl, 2,4-di(4′-hydroxyphenyl)-2-methylbutane, α,α′-di(4-hydroxyphenyl)-p-diisopropylbenzene, 2,2-di(3′-methyl-4′-hydroxyphenyl)propane, and 2,2-di(3′-chloro-4′-hydroxyphenyl)propane, and in particular to 2,2-di(4′-hydroxyphenyl)propane, 2,2-di(3′,5-dichlorodihydroxyphenyl)propane, 1,1-di(4′-hydroxyphenyl)cyclohexane, 3,4′-dihydroxybenzophenone, 4,4′-dihydroxydiphenyl sulfone and 2,2-di(3′,5′-dimethyl-4′-hydroxyphenyl)propane and mixtures of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Products of this type are known and are described in the literature, e.g. in U.S. Pat. No. 3,651,014. Corresponding products are also available commercially, e.g. Hytrel® (DuPont).

According to the invention, materials whose use is preferred as polyesters and therefore likewise as component A) also include halogen-free polycarbonates. Examples of suitable halogen-free polycarbonates are those based on diphenols of the general formula (VI)

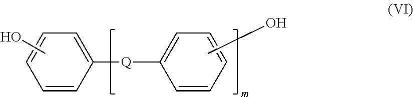

where
Q is a single bond, a C₁-C₈-alkylene, C₂-C₃-alkylidene, C₃-C₆-cycloalkylidene group, or a C₆-C₁₂-arylene group, or —O—, —S— or —SO₂—, and m is a whole number from 0 to 2.

The phenylene radicals of the diphenols may also have substituents, such as C₁-C₆-alkyl or C₁-C₆-alkoxy.

Examples of preferred diphenols of the formula (VI) are hydroquinone, resorcinol, 4,4′-dihydroxybiphenyl, 2,2-bis(4-hydroxyphenyl)propane, 2,4-bis(4-hydroxyphenyl)-2-methylbutane and 1,1-bis(4-hydroxyphenyl)cyclohexane. Particular preference is given to 2,2-bis-(4-hydroxyphenyl)propane and 1,1-bis(4-hydroxyphenyl)cyclohexane, and also to 1,1-bis-(4-hydroxyphenyl)-3,3,5-trimethylcyclohexane.

Either homopolycarbonates or copolycarbonates are suitable as component A), and preference is given to the copolycarbonates of bisphenol A, as well as to bisphenol A homopolymer.

Suitable polycarbonates may be branched in a known manner, specifically and preferably by incorporating from 0.05 to 2.0 mol %, based on the total of the diphenols used, of at least trifunctional compounds, for example those having three or more phenolic OH groups.

Polycarbonates which have proven particularly suitable have relative viscosities ηᵣₑₗ of from 1.10 to 1.50, in particular from 1.25 to 1.40. This corresponds to an average molar mass M_{w} (weight-average) of from 10 000 to 200 000 g/mol, preferably from 20 000 to 80 000 g/mol.

The diphenols of the formula (VI) mentioned above are widely known or can be prepared by known processes.

The polycarbonates may, for example, be prepared by reacting the diphenols with phosgene in the interfacial process, or with phosgene in the homogeneous-phase process (known as the pyridine process), and in each case the desired molecular weight may be achieved in a known manner by using an appropriate amount of known chain terminators. (In relation to polydiorganosiloxane-containing polycarbonates see, for example, DE-A 33 34 782.)

Examples of suitable chain terminators are phenol, p-tert-butylphenol, or else long-chain alkylphenols, such as 4-(1,3-tetramethylbutyl)phenol as in DE-A 28 42 005, or monoalkylphenols, or dialkylphenols with a total of from 8 to 20 carbon atoms in the alkyl substituents as in DE-A-35 06 472, such as p-nonylphenol, 3,5-di-tert-butylphenol, p-tert-octylphenol, p-dodecylphenol, 2-(3,5-dimethylheptyl)phenol and 4-(3,5-dimethylheptyl)phenol.

For the purposes of the present invention, halogen-free polycarbonates are polycarbonates composed of halogen-free diphenols, of halogen-free chain terminators and, if used, halogen-free branching agents, where the content of subordinate amounts at the ppm level of hydrolyzable chlorine, resulting, for example, from the preparation of the polycarbonates with phosgene in the interfacial process, is not regarded as meriting the term halogen-containing for the purposes of the invention. Polycarbonates of this type with contents of hydrolyzable chlorine at the ppm level are halogen-free polycarbonates for the purposes of the present invention.

Other suitable components A) that may be mentioned as preferred are amorphous polyester carbonates, where during the preparation process phosgene has been replaced by aromatic dicarboxylic acid units, such as isophthalic acid and/or terephthalic acid units. Reference may be made at this point to EP-A 711 810 for further details.

EP-A 365 916 describes other suitable copolycarbonates having cycloalkyl radicals as monomer units.

It is also possible for bisphenol A to be replaced by bisphenol TMC. Polycarbonates of this type are obtainable from Bayer MaterialScience AG with the trademark APEC HT®.

However, particular preference is given according to the invention to the use of the polyamides or polyesters described above as component A).

The molding compositions to be used according to the invention can comprise, as component B), B1) copolymers, preferably random copolymers composed of at least one olefin, preferably α-olefin, and of at least one methacrylate or acrylate of an aliphatic alcohol. In one preferred embodiment, the materials are random copolymers composed of at least one olefin, preferably α-olefin, and of at least one methacrylate or acrylate, where the MFI is not less than 100 g/10 min, preferably 150 g/10 min, particularly preferably 300 g/10 min, and where the MFI (melt flow index) was always measured or determined for the purposes of the present invention at 190° C., using a test weight of 2.16 kg. The upper limit of the MFI is around 900 g/10 min.

In one particularly preferred embodiment, the copolymer B1) is composed of less than 4% by weight, particularly preferably less than 1.5% by weight, and very particularly preferably 0% by weight, of monomer units which contain further reactive functional groups selected from the group consisting of epoxides, oxetanes, anhydrides, imides, aziridines, furans, acids, amines, and oxazolines.

Olefins, preferably α-olefins, suitable as constituent of the copolymers B1) preferably have from 2 to 10 carbon atoms, and can be unsubstituted or can have substitution by one or more aliphatic, cycloaliphatic, or aromatic groups.

Preferred olefins are those selected from the group consisting of ethene, propene, 1-butene, 1-pentene, 1-hexene, 1-octene, 3-methyl-1-pentene. Particularly preferred olefins are ethene and propene, and ethene is very particularly preferred.

Mixtures of the olefins described are also suitable.

In another preferred embodiment, the further reactive functional groups of the copolymer B1), selected from the group consisting of epoxides, oxetanes, anhydrides, imides, aziridines, furans, acids, amines, oxazolines, are introduced exclusively by way of the olefins into the copolymer B1).

The content of the olefin in the copolymer B1) is from 50 to 90% by weight, preferably from 55 to 75% by weight.

The copolymer B1) is further defined via the second constituent alongside the olefin. A suitable second constituent is alkyl esters or arylalkyl esters of acrylic acid or methacrylic acid whose alkyl or arylalkyl group is formed from 1 to 30 carbon atoms. The alkyl or arylalkyl group here can be linear or branched, and also can contain cycloaliphatic or aromatic groups, and alongside this can also have substitution by one or more ether or thioether functions. Other suitable methacrylates or acrylates in this connection are those synthesized from an alcohol component based on oligoethylene glycol or on oligopropylene glycol having only one hydroxy group and at most 30 carbon atoms.

By way of example, the alkyl group or arylalkyl group of the methacrylate or acrylate can have been selected from the group consisting of methyl, ethyl, n-propyl, isopropyl, n-butyl, isobutyl, tert-butyl, sec-butyl, 1-pentyl, 1-hexyl, 2-hexyl, 3-hexyl, 1-heptyl, 3-heptyl, 1-octyl, 1-(2-ethyl)hexyl, 1-nonyl, 1-decyl, 1-dodecyl, 1-lauryl or 1-octadecyl. Preference is given to alkyl groups or arylalkyl groups having from 6 to 20 carbon atoms. Preference is particularly also given to branched alkyl groups which have the same number of carbon atoms as linear alkyl groups but give a lower glass transition temperature T_{G}.

According to the invention, an aryl group is a molecular moiety having an aromatic skeleton, preferably a phenyl radical.

Particular preference according to the invention is given to copolymers B1) in which the olefin is copolymerized with 2-ethylhexyl acrylate. Mixtures of the acrylates or methacrylates described are also suitable.

It is preferable here to use more than 60% by weight, particularly preferably more than 90% by weight and very particularly preferably 100% by weight, of 2-ethylhexyl acrylate, based on the total amount of acrylate and methacrylate in copolymer B1).

In an embodiment to which further preference is given, the further reactive functional groups selected from the group consisting of epoxides, oxetanes, anhydrides, imides, aziridines, furans, acids, amines, oxazolines in the copolymer B1) are introduced exclusively by way of the acrylate or methacrylate into the copolymer B1).

The content of the acrylate or methacrylate in the copolymer B1) is from 10 to 50% by weight, preferably from 25 to 45% by weight.

A feature of suitable copolymers B1), alongside their constitution, is low molecular weight, where the MFI value (melt flow index) measured at 190° C. using a load of 2.16 kg is at least 100 g/10 min, preferably at least 150 g/10 min, particularly preferably at least 300 g/10 min. The upper limit of the MFI is around 900 g/10 min.

Copolymers which are particularly suitable as component B1) are those selected from the group of materials supplied by Atofina with the trade mark Lotryl® EH, these usually being used as hot-melt adhesives.

The inventive molding compositions can comprise, as component B) and as alternative to B1), from 0.01 to 50% by weight, preferably from 0.5 to 20% by weight and in particular from 0.7 to 10% by weight, of B2) of at least one highly branched or hyperbranched polycarbonate with an OH number of from 1 to 600 mg KOH/g of polycarbonate, preferably from 10 to 550 mg KOH/g of polycarbonate and in particular from 50 to 550 mg KOH/g of polycarbonate (to DIN 53240, Part 2) or can be present in a mixture with at least one of the other flow improvers B1), B3) or B4).

For the purposes of this invention, hyperbranched polycarbonates B2) are non-crosslinked macromolecules having hydroxy groups and carbonate groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%.

“Dendrimeric” in the context of the present invention means that the degree of branching is from 99.9 to 100%. See H. Frey et al., Acta Polym. 1997, 48, 30 for the definition of “degree of branching”.

Component B2) preferably has a number-average molar mass Mn of from 100 to 15 000 g/mol, preferably from 200 to 12 000 g/mol, and in particular from 500 to 10 000 g/mol (GPC, PMMA standard).

The glass transition temperature Tg is in particular from −80 to +140° C., preferably from −60 to 120° C. (from DSC, DIN 53765).

In particular, the viscosity (mPas) at 23° C. (to DIN 53019) is from 50 to 200 000, in particular from 100 to 150 000, and very particularly preferably from 200 to 100 000.

Component B2) is preferably obtainable via a process which comprises at least the following steps:
a) reaction of at least one organic carbonate (CA) of the general formula RO[(CO)]ₙOR with at least one aliphatic, aliphatic/aromatic or aromatic alcohol (AL) which has at least 3 OH groups, with elimination of alcohols ROH to give one or more condensates (K), where each R, independently of the others, is a straight-chain or branched aliphatic, aromatic/aliphatic or aromatic hydrocarbon radical having from 1 to 20 carbon atoms, and where the radicals R may also have bonding to one another to form a ring, and n is a whole number from 1 to 5, or
ab) reaction of phosgene, diphosgene, or triphosgene with alcohol (AL) mentioned under a), with elimination of hydrogen chloride, or
b) intermolecular reaction of the condensates (K) to give a highly functional, highly branched, or highly functional, hyperbranched polycarbonate, where the quantitative proportion of the OH groups to the carbonates in the reaction mixture is selected in such a way that the condensates (K) have an average of either one carbonate group and more than one OH group or one OH group and more than one carbonate group.

Phosgene, diphosgene, or triphosgene may be used as starting material, but preference is given to organic carbonates.

Each of the radicals R of the organic carbonates (CA) used as starting material and having the general formula RO[(CO)]ₙOR is, independently of the others, a straight-chain or branched aliphatic, aromatic/aliphatic or aromatic hydrocarbon radical having from 1 to 20 carbon atoms. The two radicals R may also have bonding to one another to form a ring. The radical is preferably an aliphatic hydrocarbon radical, and particularly preferably a straight-chain or branched alkyl radical having from 1 to 5 carbon atoms, or a substituted or unsubstituted phenyl radical.

In the formula RO[(CO)]ₙOR, n is preferably from 1 to 3, in particular 1. In particular, simple carbonates of the formula RO(CO)OR are used.

By way of example, dialkyl or diaryl carbonates may be prepared from the reaction of aliphatic, araliphatic, or aromatic alcohols, preferably monoalcohols, with phosgene. They may also be prepared by way of oxidative carbonylation of the alcohols or phenols by means of CO in the presence of noble metals, oxygen, or NOₓ. In relation to preparation methods for diaryl or dialkyl carbonates, see also “Ullmann's Encyclopedia of Industrial Chemistry”, 6th edition, 2000 Electronic Release, Verlag Wiley-VCH.

Examples of suitable carbonates comprise aliphatic, aromatic/aliphatic or aromatic carbonates, such as ethylene carbonate, propylene 1,2- or 1,3-carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, dicyclohexyl carbonate, diheptyl carbonate, dioctyl carbonate, didecyl carbonate, or didodecyl carbonate.

Examples of carbonates where n is greater than 1 comprise dialkyl dicarbonates, such as di(tert-butyl) dicarbonate, or dialkyl tricarbonates, such as di(tert-butyl)tricarbonate.

It is preferable to use aliphatic carbonates, in particular those in which the radicals comprise from 1 to 5 carbon atoms, e.g. dimethyl carbonate, diethyl carbonate, dipropyl carbonate, dibutyl carbonate, or diisobutyl carbonate.

The organic carbonates are reacted with at least one aliphatic alcohol (AL) which has at least 3 OH groups, or with mixtures of two or more different alcohols.

Examples of compounds having at least three OH groups comprise glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, diglycerol, triglycerol, polyglycerols, bis(trimethylolpropane), tris(hydroxymethyl)isocyanurate, tris(hydroxyethyl)isocyanurate, phloroglucinol, trihydroxytoluene, trihydroxydimethylbenzene, phloroglucides, hexahydroxybenzene, 1,3,5-benzenetrimethanol, 1,1,1-tris(4′-hydroxyphenyl)methane, 1,1,1-tris(4′-hydroxyphenyl)ethane, bis(trimethylolpropane), or sugars, e.g. glucose, trihydric or higher polyhydric polyetherols based on trihydric or higher polyhydric alcohols and ethylene oxide, propylene oxide, or butylene oxide, or polyesterols. Particular preference is given here to glycerol, trimethylolethane, trimethylolpropane, 1,2,4-butanetriol, pentaerythritol, and also their polyetherols based on ethylene oxide or propylene oxide.

These polyhydric alcohols may also be used in a mixture with dihydric alcohols (AL′), with the proviso that the average total OH functionality of all of the alcohols used is greater than 2. Examples of suitable compounds having two OH groups comprise ethylene glycol, diethylene glycol, triethylene glycol, 1,2- and 1,3-propanediol, dipropylene glycol, tripropylene glycol, neopentyl glycol, 1,2-, 1,3-, and 1,4-butanediol, 1,2-, 1,3-, and 1,5-pentanediol, hexanediol, cyclopentanediol, cyclohexanediol, cyclohexanedimethanol, bis(4-hydroxycyclohexyl)methane, bis(4-hydroxycyclohexyl)ethane, 2,2-bis(4-hydroxycyclohexyl)propane, 1,1′-bis(4-hydroxyphenyl)-3,3,5-trimethylcyclohexane, resorcinol, hydroquinone, 4,4′-dihydroxyphenyl, bis(4-bis(hydroxyphenyl)sulfide, bis(4-hydroxyphenyl)sulfone, bis(hydroxymethyl)benzene, bis(hydroxymethyl)toluene, bis(p-hydroxyphenyl)methane, bis(p-hydroxyphenyl)ethane, 2,2-bis(hydroxyphenyl)propane, 1,1-bis(p-hydroxyphenyl)cyclohexane, dihydroxybenzophenone, dihydric polyether polyols based on ethylene oxide, propylene oxide, butylene oxide, or mixtures of these, polytetrahydrofuran, polycaprolactone, or polyesterols based on diols and dicarboxylic acids.

The diols serve for fine adjustment of the properties of the polycarbonate. If use is made of dihydric alcohols, the ratio of dihydric alcohols (AL′), to the at least trihydric alcohols (AL) is set by the person skilled in the art and depends on the desired properties of the polycarbonate. The amount of the alcohol(s) (AL′) is generally from 0 to 39.9 mol %, based on the total amount of all of the alcohols (AL) and (AL′) taken together. The amount is preferably from 0 to 35 mol %, particularly preferably from 0 to 25 mol %, and very particularly preferably from 0 to 10 mol %.

The reaction of phosgene, diphosgene, or triphosgene with the alcohol or alcohol mixture generally takes place with elimination of hydrogen chloride, and the reaction of the carbonates with the alcohol or alcohol mixture to give the highly functional highly branched polycarbonate takes place with elimination of the monofunctional alcohol or phenol from the carbonate molecule.

The highly functional highly branched polycarbonates have termination by hydroxy groups and/or by carbonate groups after their preparation, i.e. with no further modification. They have good solubility in various solvents, e.g. in water, alcohols, such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate, or propylene carbonate.

For the purposes of this invention, a highly functional polycarbonate is a product which, besides the carbonate groups which form the polymer skeleton, further has at least three, preferably at least six, more preferably at least ten, terminal or pendant functional groups. The functional groups are carbonate groups and/or OH groups. There is in principle no upper restriction on the number of the terminal or pendant functional groups, but products having a very high number of functional groups can have undesired properties, such as high viscosity or poor solubility. The highly functional polycarbonates of the present invention mostly have not more than 500 terminal or pendant functional groups, preferably not more than 100 terminal or pendant functional groups.

When preparing the highly functional polycarbonates B2), it is necessary to adjust the ratio of the compounds comprising OH groups to phosgene or carbonate in such a way that the simplest resultant condensate (hereinafter termed condensate (K)) comprises an average of either one carbonate group or carbamoyl group and more than one OH group or one OH group and more than one carbonate group or carbamoyl group. The simplest structure of the condensate (K) composed of a carbonate (CA) and a di- or polyalcohol (B) here results in the arrangement XYn or YnX, where X is a carbonate group, Y is a hydroxy group, and n is generally a number from 1 to 6, preferably from 1 to 4, particularly preferably from 1 to 3. The reactive group which is the single resultant group here is generally termed “focal group” below.

By way of example, if during the preparation of the simplest condensate (K) from a carbonate and a dihydric alcohol the reaction ratio is 1:1, the average result is a molecule of XY type, illustrated by the general formula (VII).

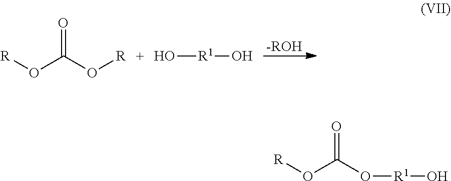

During the preparation of the condensate (K) from a carbonate and a trihydric alcohol with a reaction ratio of 1:1, the average result is a molecule of XY₂ type, illustrated by the general formula (VIII). A carbonate group is focal group here.

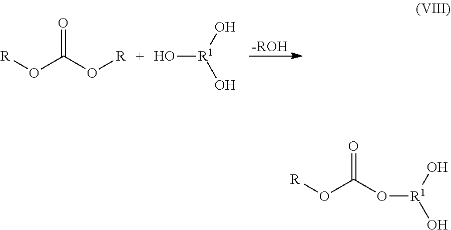

During the preparation of the condensate (K) from a carbonate and a tetrahydric alcohol, likewise with the reaction ratio 1:1, the average result is a molecule of XY₃ type, illustrated by the general formula (IX). A carbonate group is focal group here.

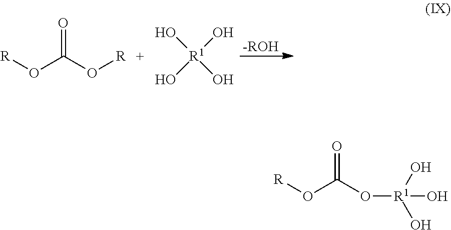

R in the formulae (VII) to (IX) has the definition given above for the organic carbonates (CA), and R¹ is an aliphatic or aromatic radical.

The condensate (K) may, by way of example, also be prepared from a carbonate and a trihydric alcohol, as illustrated by the general formula (X), the molar reaction ratio being 2:1. Here, the average result is a molecule of X₂Y type, an OH group being focal group here. In formula (X), R and R¹ are as defined in formulae (VII) to (IX).

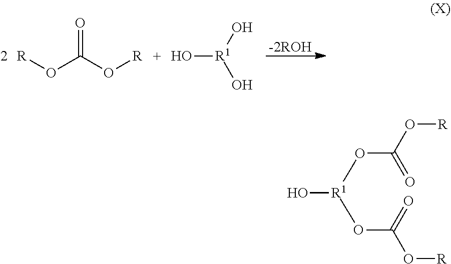

If difunctional compounds, e.g. a dicarbonate or a diol, are also added to the components, this extends the chains, as illustrated by way of example in the general formula (XI). The average result is again a molecule of XY₂ type, a carbonate group being focal group.

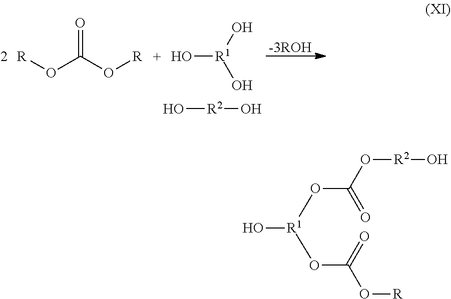

In formula (XI), R² is an organic, preferably aliphatic radical, and R and R¹ are as defined above.

It is also possible to use two or more condensates (K) for the synthesis. Here, firstly two or more alcohols or two or more carbonates may be used. Furthermore, mixtures of various condensates of different structure can be obtained via the selection of the ratio of the alcohols used and of the carbonates or the phosgenes. This may be illustrated taking the example of the reaction of a carbonate with a trihydric alcohol. If the starting materials are reacted in a ratio of 1:1, as shown in (VIII), the result is an XY₂ molecule. If the starting materials are reacted in a ratio of 2:1, as shown in (X), the result is an X₂Y molecule. If the ratio is from 1:1 to 2:1, the result is a mixture of XY₂ and X₂Y molecules.

According to the invention, the simple condensates (K) described by way of example in the formulae (VII) to (XI) preferentially react intermolecularly to form highly functional polycondensates, hereinafter termed polycondensates (P). The reaction to give the condensate (K) and to give the polycondensate (P) usually takes place at a temperature of from 0 to 250° C., preferably from 60 to 160° C., in bulk or in solution.

Use may generally be made here of any of the solvents which are inert with respect to the respective starting materials. Preference is given to use of organic solvents, e.g. decane, dodecane, benzene, toluene, chlorobenzene, xylene, dimethylformamide, dimethylacetamide, or solvent naphtha.

In one embodiment, the condensation reaction is carried out in bulk. To accelerate the reaction, the phenol or the monohydric alcohol ROH liberated during the reaction can be removed by distillation from the reaction equilibrium if appropriate at reduced pressure.

If removal by distillation is intended, it is generally advisable to use those carbonates which liberate alcohols ROH with a boiling point below 140° C. during the reaction.

Catalysts or catalyst mixtures may also be added to accelerate the reaction. Suitable catalysts are compounds which catalyze esterification or transesterification reactions, e.g. alkali metal hydroxides, alkali metal carbonates, alkali metal hydrogencarbonates, preferably of sodium, of potassium, or of cesium, tertiary amines, guanidines, ammonium compounds, phosphonium compounds, organoaluminum, organotin, organozinc, organotitanium, organozirconium, or organobismuth compounds, or else what are known as double metal cyanide (DMC) catalysts, e.g. as described in DE-A 10138216 (U.S. Pat. No. 6,646,100), or in DE-A 10147712 (WO 2003 029 240 A1).

It is preferable to use potassium hydroxide, potassium carbonate, potassium hydrogencarbonate, diazabicyclooctane (DABCO), diazabicyclononene (DBN), diazabicycloundecene (DBU), imidazoles, such as imidazole, 1-methylimidazole, or 1,2-dimethylimidazole, titanium tetrabutoxide, titanium tetraisopropoxide, dibutyltin oxide, dibutyltin dilaurate, stannous dioctoate, zirconium acetylacetonate, or a mixture thereof.

The amount of catalyst generally added is from 50 to 10 000 ppm by weight, preferably from 100 to 5000 ppm by weight, based on the amount of the alcohol mixture or alcohol used.

It is also possible to control the intermolecular polycondensation reaction via addition of the suitable catalyst or else via selection of a suitable temperature. The average molecular weight of the polymer (P) may moreover be adjusted by way of the composition of the starting components and by way of the residence time.

The condensates (K) and the polycondensates (P) prepared at an elevated temperature are usually stable at room temperature for a relatively long period.

The nature of the condensates (K) permits polycondensates (P) with different structures to result from the condensation reaction, these having branching but no crosslinking. Furthermore, in the ideal case, the polycondensates (P) have either one carbonate group as focal group and more than two OH groups or else one OH group as focal group and more than two carbonate groups. The number of the reactive groups here is the result of the nature of the condensates (K) used and the degree of polycondensation.

By way of example, a condensate (K) according to the general formula (XII) can react via triple intermolecular condensation to give two different polycondensates (P), represented in the general formulae (XII) and (XIII).

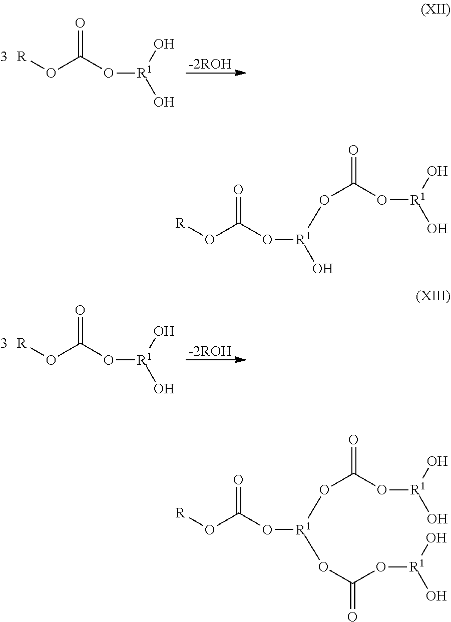

In formula (XII) and (XIII), R and R¹ are as defined above.

There are various ways of terminating the intermolecular polycondensation reaction. By way of example, the temperature may be lowered to a range where the reaction stops and the product (K) or the polycondensate (P) is storage-stable.

It is also possible to deactivate the catalyst, for example in the case of basic catalysts via addition of Lewis acids or proton acids.

In another embodiment, as soon as the intermolecular reaction of the condensate (K) has produced a polycondensate (P) with the desired degree of polycondensation, a product having groups reactive toward the focal group of (P) may be added to the product (P) to terminate the reaction. In the case of a carbonate group as focal group, by way of example, a mono-, di-, or polyamine may therefore be added. In the case of a hydroxy group as focal group, by way of example, a mono-, di-, or polyisocyanate, or a compound comprising epoxy groups, or an acid derivative which reacts with OH groups, can be added to the product (P).

The highly functional polycarbonates are mostly prepared in a pressure range from 0.1 mbar to 20 bar, preferably at from 1 mbar to 5 bar, in reactors or reactor cascades which are operated batchwise, semicontinuously, or continuously.

The inventive products can be further processed without further purification after their preparation by virtue of the abovementioned adjustment of the reaction conditions and, if appropriate, by virtue of the selection of the suitable solvent.

In another preferred embodiment, the product is stripped, i.e. freed from low-molecular-weight, volatile compounds. For this, once the desired degree of conversion has been reached the catalyst may optionally be deactivated and the low-molecular-weight volatile constituents, e.g. monoalcohols, phenols, carbonates, hydrogen chloride, or volatile oligomeric or cyclic compounds, can be removed by distillation, if appropriate with introduction of a gas, preferably nitrogen, carbon dioxide, or air, if appropriate at reduced pressure.

In another embodiment, the polycarbonates may comprise other functional groups besides the functional groups present at this stage by virtue of the reaction. The functionalization may take place during the process to increase molecular weight, or else subsequently, i.e. after completion of the actual polycondensation.

If, prior to or during the process to increase molecular weight, components are added which have other functional groups or functional elements besides hydroxy or carbonate groups, the result is a polycarbonate polymer with randomly distributed functionalities other than the carbonate or hydroxy groups.

Effects of this type can, by way of example, be achieved via addition, during the polycondensation, of compounds which bear other functional groups or functional elements, such as mercapto groups, primary, secondary or tertiary amino groups, ether groups, derivatives of carboxylic acids, derivatives of sulfonic acids, derivatives of phosphonic acids, silane groups, siloxane groups, aryl radicals, or long-chain alkyl radicals, besides hydroxy groups, carbonate groups or carbamoyl groups. Examples of compounds which may be used for modification by means of carbamate groups are ethanolamine, propanolamine, isopropanolamine, 2-(butylamino)ethanol, 2-(cyclohexylamino)ethanol, 2-amino-1-butanol, 2-(2′-aminoethoxy)ethanol or higher alkoxylation products of ammonia, 4-hydroxypiperidine, 1-hydroxyethylpiperazine, diethanolamine, dipropanolamine, diisopropanolamine, tris(hydroxymethyl)aminomethane, tris(hydroxyethyl)aminomethane, ethylenediamine, propylenediamine, hexamethylenediamine or isophoronediamine.

An example of a compound which can be used for modification with mercapto groups is mercaptoethanol. By way of example, tertiary amino groups can be produced via incorporation of N-methyldiethanolamine, N-methyldipropanolamine or N,N-dimethylethanolamine. By way of example, ether groups may be generated via co-condensation of dihydric or higher polyhydric polyetherols. Long-chain alkyl radicals can be introduced via reaction with long-chain alkanediols, and reaction with alkyl or aryl diisocyanates generates polycarbonates having alkyl, aryl, and urethane groups, or urea groups.

Ester groups can be produced via addition of dicarboxylic acids, tricarboxylic acids, for example, dimethyl terephthalate, or tricarboxylic esters.

Subsequent functionalization can be achieved by using an additional step of the process to react the resultant highly functional, highly branched, or highly functional hyperbranched polycarbonate with a suitable functionalizing reagent which can react with the OH and/or carbonate groups or carbamoyl groups of the polycarbonate.

By way of example, highly functional highly branched, or highly functional hyperbranched polycarbonates comprising hydroxy groups can be modified via addition of molecules comprising acid groups or isocyanate groups. By way of example, polycarbonates comprising acid groups can be obtained via reaction with compounds comprising anhydride groups.

Highly functional polycarbonates comprising hydroxy groups may moreover also be converted into highly functional polycarbonate polyether polyols via reaction with alkylene oxides, e.g. ethylene oxide, propylene oxide, or butylene oxide.

The molding compositions to be used for the production of the inventive hybrid-based lightweight components can comprise, as component B3), at least one hyperbranched polyester of AₓB_{y} type, where
x is at least 1.1, preferably at least 1.3, in particular at least 2 and
y is at least 2.1, preferably at least 2.5, in particular at least 3.

Use may also be made of mixtures as units A and/or B, of course.

An AₓB_{y}-type polyester is a condensate composed of an x-functional molecule A and a y-functional molecule B. By way of example, mention may be made of a polyester composed of adipic acid as molecule A (x=2) and glycerol as molecule B (y=3).

For the purposes of this invention, hyperbranched polyesters B3) are non-crosslinked macromolecules having hydroxy groups and carboxy groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%. “Dendrimeric” in the context of the present invention means that the degree of branching is from 99.9 to 100%. See H. Frey et al., Acta Polym. 1997, 48, 30 for the definition of “degree of branching”.

Component B3) preferably has a molecular weight of from 300 to 30 000 g/mol, in particular from 400 to 25 000 g/mol, and very particularly from 500 to 20 000 g/mol, determined by means of GPC, PMMA standard, dimethylacetamide eluent.

B3) preferably has an OH number of from 0 to 600 mg KOH/g of polyester, preferably from 1 to 500 mg KOH/g of polyester, in particular from 20 to 500 mg KOH/g of polyester to DIN 53240, and preferably a COOH number of from 0 to 600 mg KOH/g of polyester, preferably from 1 to 500 mg KOH/g of polyester, and in particular from 2 to 500 mg KOH/g of polyester.

The Tg (glass transition) is preferably from −50° C. to 140° C., and in particular from −50 to 100° C. (by means of DSC, to DIN 53765).

Preference is particularly given to those components B3) in which at least one OH or COOH number is greater than 0, preferably greater than 0.1, and in particular greater than 0.5.

The component B3) is obtainable via the processes described below, for example by reacting
(m) one or more dicarboxylic acids or one or more derivatives of the same with one or more at least trihydric alcohols

or
(n) one or more tricarboxylic acids or higher polycarboxylic acids or one or more derivatives of the same with one or more diols in the presence of a solvent and optionally in the presence of an inorganic, organometallic, or low-molecular-weight organic catalyst, or of an enzyme. The reaction in solvent is the preferred preparation method.

Highly functional hyperbranched polyesters B3) have molecular and structural non-uniformity. Their molecular non-uniformity distinguishes them from dendrimers, and they can therefore be prepared at considerably lower cost.

Among the dicarboxylic acids which can be reacted according to variant (m) are, by way of example, oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, and cis- and trans-cyclopentane-1,3-dicarboxylic acid, and the abovementioned dicarboxylic acids may have substitution by one or more radicals selected from C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl, C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl; alkylene groups, such as methylene or ethylidene, or C₆-C₁₄-aryl groups, such as phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl, and 2-naphthyl, particularly preferably phenyl.

Examples which may be mentioned as representatives of substituted dicarboxylic acids are: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

Among the dicarboxylic acids which can be reacted according to variant (m) are also ethylenically unsaturated acids, such as maleic acid and fumaric acid, and aromatic dicarboxylic acids, such as phthalic acid, isophthalic acid or terephthalic acid.

It is also possible to use mixtures of two or more of the abovementioned representative compounds.

The dicarboxylic acids may either be used as they stand or be used in the form of derivatives.

Derivatives are preferably
the relevant anhydrides in monomeric or else polymeric form,
mono- or dialkyl esters, preferably mono- or dimethyl esters, or the corresponding mono- or diethyl esters, or else the mono- and dialkyl esters derived from higher alcohols, such as n-propanol, isopropanol, n-butanol, isobutanol, tert-butanol, n-pentanol, n-hexanol,
and also mono- and divinyl esters, and
mixed esters, preferably methyl ethyl esters.

However, it is also possible to use a mixture composed of a dicarboxylic acid and one or more of its derivatives. Equally, it is possible to use a mixture of two or more different derivatives of one or more dicarboxylic acids.

It is particularly preferable to use succinic acid, glutaric acid, adipic acid, phthalic acid, isophthalic acid, terephthalic acid, or the mono- or dimethyl esters thereof. It is very particularly preferable to use adipic acid.

Examples of at least trihydric alcohols which may be reacted are: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or ditrimethylolpropane, trimethylolethane, pentaerythritol or dipentaerythritol; sugar alcohols, such as mesoerythritol, threitol, sorbitol, mannitol, or mixtures of the above at least trihydric alcohols. It is preferable to use glycerol, trimethylolpropane, trimethylolethane, and pentaerythritol.

Examples of tricarboxylic acids or polycarboxylic acids which can be reacted according to variant (n) are benzene-1,2,4-tricarboxylic acid, benzene-1,3,5-tricarboxylic acid, benzene-1,2,4,5-tetracarboxylic acid, and mellitic acid.

Tricarboxylic acids or polycarboxylic acids may be used in the inventive reaction either as they stand or else in the form of derivatives.

Derivatives are preferably
the relevant anhydrides in monomeric or else polymeric form,
mono-, di-, or trialkyl esters, preferably mono-, di-, or trimethyl esters, or the corresponding mono-, di-, or triethyl esters, or else the mono-, di-, and triesters derived from higher alcohols, such as n-propanol, isopropanol, n-butanol, isobutanol, tert-butanol, n-pentanol, n-hexanol, or else mono-, di-, or trivinyl esters
and mixed methyl ethyl esters.

It is also possible to use a mixture composed of a tri- or polycarboxylic acid and one or more of its derivatives. It is likewise possible to use a mixture of two or more different derivatives of one or more tri- or polycarboxylic acids, in order to obtain component B3).

Examples of diols used for variant (n) are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methylpentane-2,4-diol, 2,4-dimethylpentane-2,4-diol, 2-ethylhexane-1,3-diol, 2,5-dimethylhexane-2,5-diol, 2,2,4-trimethylpentane-1,3-diol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H or mixtures of two or more representative compounds of the above compounds, where n is a whole number and n=4. One, or else both, hydroxy groups here in the abovementioned diols may also be replaced by SH groups. Preference is given to ethylene glycol, propane-1,2-diol, and diethylene glycol, triethylene glycol, dipropylene glycol, and tripropylene glycol.

The molar ratios of the molecules A to molecules B in the AₓB_{y} polyester in the variants (m) and (n) are from 4:1 to 1:4, in particular from 2:1 to 1:2.

The at least trihydric alcohols reacted according to variant (m) may have hydroxy groups of which all have identical reactivity. Preference is also given here to at least trihydric alcohols whose OH groups initially have identical reactivity, but where reaction with at least one acid group can induce a fall-off in reactivity of the remaining OH groups as a result of steric or electronic effects. By way of example, this applies when trimethylolpropane or pentaerythritol is used.

However, the at least trihydric alcohols reacted according to variant (m) may also have hydroxy groups having at least two different chemical reactivities.

The different reactivity of the functional groups here may derive either from chemical causes (e.g. primary/secondary/tertiary OH group) or from steric causes.

By way of example, the triol may comprise a triol which has primary and secondary hydroxy groups, a preferred example being glycerol.

When the inventive reaction is carried out according to variant (m), it is preferable to operate in the absence of diols and of monohydric alcohols.

When the inventive reaction is carried out according to variant (n), it is preferable to operate in the absence of mono- or dicarboxylic acids.

The process is carried out in the presence of a solvent. By way of example, hydrocarbons are suitable, such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethylbenzene, chlorobenzene, and ortho- and meta-dichlorobenzene. Other solvents very particularly suitable in the absence of acidic catalysts are: ethers, such as dioxane or tetrahydrofuran, and ketones, such as methyl ethyl ketone and methyl isobutyl ketone.

The amount of solvent added is at least 0.1% by weight, based on the weight of the starting materials used and to be reacted, preferably at least 1% by weight, and particularly preferably at least 10% by weight. It is also possible to use excesses of solvent, based on the weight of starting materials used and to be reacted, e.g. from 1.01 to 10 times the amount. Solvent amounts of more than 100 times the weight of the starting materials used and to be reacted are not advantageous, because the reaction rate decreases markedly at markedly lower concentrations of the reactants, giving uneconomically long reaction times.

To carry out the process, operations may be carried out in the presence of a dehydrating agent as additive, added at the start of the reaction. Suitable examples are molecular sieves, in particular 4 Å molecular sieve, MgSO₄, and Na₂SO₄. During the reaction it is also possible to add further dehydrating agent or to replace dehydrating agent by fresh dehydrating agent. During the reaction it is also possible to remove the water or alcohol formed by distillation and, for example, to use a water trap.

The process may be carried out in the absence of acidic catalysts. It is preferable to operate in the presence of an acidic inorganic, organometallic, or organic catalyst, or a mixture composed of two or more acidic inorganic, organometallic, or organic catalysts.

Examples of acidic inorganic catalysts are sulfuric acid, phosphoric acid, phosphonic acid, hypophosphorous acid, aluminum sulfate hydrate, alum, acidic silica gel (pH=6, in particular=5), and acidic aluminum oxide. Examples of other compounds which can be used as acidic inorganic catalysts are aluminum compounds of the general formula Al(OR*)₃ and titanates of the general formula Ti(OR*)₄, where each of the radicals R* may be identical or different and is selected independently of the others from C₁-C₁₀-alkyl radicals, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl, C₃-C₁₂-cycloalkyl radicals, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl.

Each of the radicals R* in Al(OR)₃ or Ti(OR)₄ is preferably identical and selected from isopropyl or 2-ethylhexyl.

Examples of preferred acidic organometallic catalysts are selected from dialkyltin oxides R*₂SnO, where R* is defined as above. A particularly preferred representative compound for acidic organometallic catalysts is di-n-butyltin oxide, which is commercially available as “oxo-tin”, or di-n-butyltin dilaurate.

Preferred acidic organic catalysts are acidic organic compounds having, by way of example, phosphate groups, sulfonic acid groups, sulfate groups, or phosphonic acid groups. Particular preference is given to sulfonic acids, such as para-toluenesulfonic acid. Acidic ion exchangers may also be used as acidic organic catalysts, e.g. polystyrene resins comprising sulfonic acid groups and crosslinked with about 2 mol % of divinylbenzene.

It is also possible to use combinations of two or more of the abovementioned catalysts. It is also possible to use an immobilized form of those organic or organometallic, or else inorganic catalysts which take the form of discrete molecules.

If the intention is to use acidic inorganic, organometallic, or organic catalysts, according to the invention the amount used is from 0.1 to 10% by weight, preferably from 0.2 to 2% by weight, of catalyst.

The preparation process for component B3) is carried out under an inert gas atmosphere, for example under carbon dioxide, nitrogen or a noble gas, among which particular mention may be made of argon. The inventive process is carried out at temperatures of from 60 to 200° C. It is preferable to operate at temperatures of from 130 to 180° C., in particular up to 150° C., or below that temperature. Maximum temperatures up to 145° C. are particularly preferred, and temperatures up to 135° C. are very particularly preferred. The pressure conditions for the inventive process are not critical. It is possible to operate at markedly reduced pressure, e.g. at from 10 to 500 mbar. The process may also be carried out at pressures above 500 mbar. The reaction at atmospheric pressure is preferred for reasons of simplicity; however, conduct at slightly increased pressure is also possible, e.g. up to 1200 mbar. It is also possible to operate at markedly increased pressure, e.g. at pressures up to 10 bar. Reaction at atmospheric pressure is preferred. The reaction time is usually from 10 minutes to 25 hours, preferably from 30 minutes to 10 hours, and particularly preferably from one to 8 hours.

Once the reaction has ended, the highly functional hyperbranched polyesters B3) can easily be isolated, e.g. by removing the catalyst by filtration and concentrating the mixture, the concentration process here usually being carried out at reduced pressure. Other work-up methods with good suitability are precipitation after addition of water, followed by washing and drying.

Component B3) can also be prepared in the presence of enzymes or decomposition products of enzymes (according to DE-A 10 163 163). For the purposes of the present invention, the term acidic organic catalysts does not include the dicarboxylic acids reacted according to the invention.

It is preferable to use lipases or esterases. Lipases and esterases with good suitability are Candida cylindracea, Candida lipolytica, Candida rugosa, Candida antarctica, Candida utilis, Chromobacterium viscosum, Geotrichum viscosum, Geotrichum candidum, Mucor javanicus, Mucor mihei, pig pancreas, Pseudomonas spp., Pseudomonas fluorescens, Pseudomonas cepacia, Rhizopus arrhizus, Rhizopus delemar, Rhizopus niveus, Rhizopus oryzae, Aspergillus niger, Penicillium roquefortii, Penicillium camembertii, or esterase from Bacillus spp. and Bacillus thermoglucosidasius. Candida antarctica lipase B is particularly preferred. The enzymes listed are commercially available, for example from Novozymes Biotech Inc., Denmark.

The enzyme is preferably used in immobilized form, for example on silica gel or Lewatit®. The processes for immobilizing enzymes are known, e.g. from Kurt Faber, “Biotransformations in Organic Chemistry”, 3rd edition 1997, Springer Verlag, Chapter 3.2 “Immobilization” pp. 345-356. Immobilized enzymes are commercially available, for example from Novozymes Biotech Inc., Denmark.

The amount of immobilized enzyme to be used is from 0.1 to 20% by weight, in particular from 10 to 15% by weight, based on the total weight of the starting materials used and to be reacted.

The process using enzymes is carried out at temperatures above 60° C. It is preferable to operate at temperatures of 100° C. or below that temperature. Preference is given to temperatures up to 80° C., very particular preference is given to temperatures of from 62 to 75° C., and still more preference is given to temperatures of from 65 to 75° C.

The process using enzymes is carried out in the presence of a solvent. Examples of suitable compounds are hydrocarbons, such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethylbenzene, chlorobenzene and ortho- and meta-dichlorobenzene. Other very particularly suitable solvents are: ethers, such as dioxane or tetrahydrofuran, and ketones, such as methyl ethyl ketone and methyl isobutyl ketone.

The amount of solvent added is at least 5 parts by weight, based on the weight of the starting materials used and to be reacted, preferably at least 50 parts by weight, and particularly preferably at least 100 parts by weight. Amounts of more than 10 000 parts by weight of solvent are undesirable, because the reaction rate decreases markedly at markedly lower concentrations, giving uneconomically long reaction times.

The process using enzymes is carried out at pressures above 500 mbar. Preference is given to the reaction at atmospheric pressure or slightly increased pressure, for example at up to 1200 mbar. It is also possible to operate under markedly increased pressure, for example at pressures up to 10 bar. The reaction at atmospheric pressure is preferred.

The reaction time for the process using enzymes is usually from 4 hours to 6 days, preferably from 5 hours to 5 days, and particularly preferably from 8 hours to 4 days.

Once the reaction has ended, the highly functional hyperbranched polyesters can be isolated, e.g. by removing the enzyme by filtration and concentrating the mixture, this concentration process usually being carried out at reduced pressure. Other work-up methods with good suitability are precipitation after addition of water, followed by washing and drying.

The highly functional, hyperbranched polyesters B3) obtainable by this process using enzymes feature particularly low contents of discolored and resinified material. For the definition of hyperbranched polymers, see also: P. J. Flory, J. Am. Chem. Soc. 1952, 74, 2718, and A. Sunder et al., Chem. Eur. J. 2000, 6, no. 1, 1-8. However, in the context of the present invention, “highly functional hyperbranched” means that the degree of branching, i.e. the average number of dendritic linkages plus the average number of end groups per molecule, is from 10 to 99.9%, preferably from 20 to 99%, particularly preferably from 30 to 90% (see in this connection H. Frey et al. Acta Polym. 1997, 48, 30).

The molar mass M_{w} of the polyesters B3) is from 500 to 50 000 g/mol, preferably from 1000 to 20 000 g/mol, particularly preferably from 1000 to 19 000 g/mol. The polydispersity is from 1.2 to 50, preferably from 1.4 to 40, particularly preferably from 1.5 to 30, and very particularly preferably from 1.5 to 10. They are usually very soluble, i.e. clear solutions can be prepared using up to 50% by weight, in some cases even up to 80% by weight, of the polyesters B3) in tetrahydrofuran (THF), n-butyl acetate, ethanol, and numerous other solvents, with no gel particles detectable by the naked eye.

The highly functional hyperbranched polyesters B3) are carboxy-terminated, carboxy- and hydroxy-terminated, but preferably only hydroxy-terminated.

The hyperbranched polycarbonates B2)/polyesters B3) used are particles of size from 20 to 500 nm. These nanoparticles are in finely dispersed form within the polymer blend, and the size of the particles in the compounded material is from 20 to 500 nm, preferably from 50 to 300 nm.

Compounded materials of this type are available commercially, for example in the form of Ultradur® high speed.

The low-molecular-weight polyalkylene glycol esters (PAGE) B4) which are likewise to be used as flow improvers and which have the general formula (I)

R—COO—(Z—O)ₙOC—R (I)

in which
R is a branched or straight-chain alkyl group having from 1 to 20 carbon atoms,
Z is a branched or straight-chain C₂-C₁₅-alkylene group, and
n is a whole number from 2 to 20

are known from WO 98/11164 A1. Particular preference is given to triethylene glycol bis(2-ethylhexanoate) (TEG-EH), which is marketed as TEG-EH-Plasticizer, CAS-No. 94-28-0, by Eastman Chemical B.V., The Hague, The Netherlands.

If a mixture of the B) components are used, the ratios of components B1) to B2) or B2) to B3) or B1) to B3) or B1) to B4) or B2) to B4) or B3) to B4) are preferably from 1:20 to 20:1, in particular from 1:15 to 15:1, and very particularly from 1:5 to 5:1. If a ternary mixture composed of, for example, B1), B2), and B3) is used, the mixing ratio is preferably from 1:1:20 to 1:20:1, or up to 20:1:1. This likewise applies to ternary mixtures using B4).

In one preferred embodiment, the present invention provides structural organosheet-components composed of a parent body which has reinforcing structures and which is based on an organosheet, where the reinforcing structures have been securely bonded to the parent body and are composed of molded-on thermoplastic, wherein the thermoplastic used comprises polymer molding compositions comprising A) from 99.99 to 10 parts by weight, preferably from 99.5 to 40 parts by weight, particularly preferably from 99.0 to 55 parts by weight, of polyamide, and

B1) from 0.01 to 50 parts by weight, preferably from 0.25 to 20 parts by weight, particularly preferably from 1.0 to 15 parts by weight, of at least one copolymer composed of at least one olefin, preferably α-olefin, and of at least one methacrylate or acrylate of an aliphatic alcohol, preferably of an aliphatic alcohol having from 1 to 30 carbon atoms, where the MFI is not less than 100 g/10 min, and where the MFI (melt flow index) is measured or determined at 190° C., using a test weight of 2.16 kg.

In one particularly preferred embodiment, the present invention provides structural organosheet-components obtainable from polymer molding compositions of components A) and B1), where the parent body thereof, based on an organosheet, has the shape of a shell, where the external or internal space thereof additionally has reinforcing structures which have been securely bonded to the parent body and which are composed of the same molded-on thermoplastic, where, in an alternative embodiment, the bonding of these to the parent body is additionally achieved at discrete connection sites. For the purposes of the present invention, discrete connection sites are perforations within the parent body, where the thermoplastic extends through these perforations and across the surface of the perforations, thus additionally reinforcing the intrinsically secure interlock bond that arises across the surface of the parent organosheet body. The reinforcing structures are preferably of a rib shape or honeycomb shape.

However, in one preferred embodiment the present invention also provides structural organosheet-components where the thermoplastic used comprises polymer molding compositions comprising from 99.99 to 10 parts by weight, preferably from 99.5 to 40 parts by weight, particularly preferably from 99.0 to 55 parts by weight, of polyamide obtained by polymerizing a mixture of monomers which encompasses at least

a) monomers of the general formula (II) R₁-(-D-Z)ₘ,

b) monomers of the general formula (IIIa) X—R₂—Y and

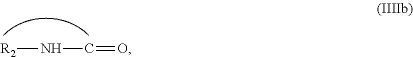

c) monomers of the general formula (IV) Z—R₃—Z, in which

R₁ is a linear or cyclic, aromatic or aliphatic carbon radical which encompasses at least two carbon atoms and can encompass heteroatoms,

D is a covalent bond or an aliphatic hydrocarbon radical having from 1 to 6 carbon atoms,

Z is a primary amine radical or a carboxy group,

R₂ and R₃ are identical or different and are aliphatic, cycloaliphatic, or aromatic, substituted or unsubstituted hydrocarbon radicals which encompass from 2 to 20 carbon atoms and can encompass heteroatoms, and

Y is a primary amine radical if X is a carbonyl radical, or Y is a carbonyl radical if X is a primary amine radical, where m is a whole number from 3 to 8.

In another particularly preferred embodiment, the present invention therefore also provides structural organosheet-components obtainable from polymer molding compositions of the abovementioned polyamides obtainable from the monomers (II), (IIIa), (IIIb), and (IV), where the parent body thereof, based on an organosheet, has the shape of a shell, where the external or internal space thereof additionally has reinforcing structures which have been securely bonded to the parent body and which are composed of the same molded-on thermoplastic, and where, in an alternative embodiment, the bonding of these to the parent body is additionally achieved at discrete connection sites.

In another preferred embodiment of the present invention, molding compositions used for the structural organosheet-components also comprise, in addition to components A) and B),
C) from 0.001 to 75 parts by weight, preferably from 10 to 70 parts by weight, particularly preferably from 20 to 65 parts by weight, with particular preference from 30 to 65 parts by weight, of a filler or a reinforcing material.

The filler or reinforcing material used can also comprise a mixture composed of two or more different fillers and/or reinforcing materials, for example based on talc, mica, silicate, quartz, titanium dioxide, wollastonite, kaolin, amorphous silicas, magnesium carbonate, chalk, feldspar, barium sulfate, glass beads and/or fibrous fillers and/or reinforcing materials based on carbon fibers and/or glass fibers. It is preferable to use mineral particulate fillers based on talc, mica, silicate, quartz, titanium dioxide, wollastonite, kaolin, amorphous silicas, magnesium carbonate, chalk, feldspar, barium sulfate and/or glass fibers. It is particularly preferable to use mineral particulate fillers based on talc, wollastonite, kaolin and/or glass fibers, very particular preference being given to glass fibers.

Particularly for applications in which isotropy in dimensional stability and high thermal dimensional stability is demanded, as for example in motor vehicle applications for external bodywork parts, it is preferable to use mineral fillers, in particular talc, wollastonite or kaolin.

Particular preference is moreover also given to the use of acicular mineral fillers. According to the invention, the term acicular mineral fillers means a mineral filler having pronounced acicular character. An example that may be mentioned is acicular wollastonites. The length:diameter ratio of the mineral is preferably from 2:1 to 35:1, particularly preferably from 3:1 to 19:1, with particular preference from 4:1 to 12:1. The average particle size, determined using a CILAS GRANULOMETER, of the inventive acicular minerals is preferably smaller than 20 μm, particularly preferably smaller than 15 μm, with particular preference smaller than 10 μm.

The filler and/or reinforcing material can, if appropriate, have been surface-modified, for example with a coupling agent or coupling-agent system, for example based on silane. However, this pre-treatment is not essential. However, in particular when glass fibers are used it is also possible to use polymer dispersions, film-formers, branching agents and/or glass-fiber-processing aids, in addition to silanes.

The glass fibers whose use is particularly preferred according to the invention are added in the form of continuous-filament fibers or in the form of chopped or ground glass fibers, their fiber diameter generally being from 7 to 18 μm, preferably from 9 to 15 μm. The fibers can have been provided with a suitable size system and with a coupling agent or coupling-agent system, for example based on silane.

Coupling agents based on silane and commonly used for the pre-treatment are silane compounds, preferably silane compounds of the general formula (XIV)

(X—(CH₂)_{q})ₖ—Si—(O—CᵣH₂ᵣ₊₁)₄₋ₖ (XIV)

in which

X is NH₂—, HO— or

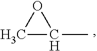

q is a whole number from 2 to 10, preferably from 3 to 4,

r is a whole number from 1 to 5, preferably from 1 to 2 and

k is a whole number from 1 to 3, preferably 1.

Coupling agents to which further preference is given are silane compounds from the group of aminopropyltrimethoxysilane, aminobutyltrimethoxysilane, aminopropyltriethoxysilane, aminobutyltriethoxysilane, and also the corresponding silanes which have a glycidyl group as substituent X.

The amounts generally used of the silane compounds for surface coating for modification of the fillers is from 0.05 to 2% by weight, preferably from 0.25 to 1.5% by weight and in particular from 0.5 to 1% by weight, based on the mineral filler.

As a result of the processing to give the molding composition or molding, the d97 value or d50 value of the particulate fillers can be smaller in the molding composition or in the molding than in the fillers originally used. As a result of the processing to give the molding composition or molding, the length distributions of the glass fibers in the molding composition or the molding can be shorter than those originally used.

In an alternative preferred embodiment, the polymer molding compositions to be used for the production of the structural organosheet-components of the invention can also, if appropriate, comprise in addition to components A) and B) and C), or instead of C),
D) from 0.001 to 30 parts by weight, preferably from 5 to 25 parts by weight, particularly preferably from 9 to 19 parts by weight, of at least one flame-retardant additive.

The flame-retardant additive or flame retardant D) used can comprise commercially available organic halogen compounds with synergists or can comprise commercially available organic nitrogen compounds or organic/inorganic phosphorus compounds, individually or in a mixture. It is also possible to use flame-retardant additives such as magnesium hydroxide or Ca Mg carbonate hydrates (e.g. DE-A 4 236 122(=CA 210 9024 A1)). It is also possible to use salts of aliphatic or aromatic sulfonic acids. Examples that may be mentioned of halogen-containing, in particular brominated and chlorinated, compounds are: ethylene-1,2-bistetrabromophthalimide, epoxidized tetrabromobisphenol A resin, tetrabromobisphenol A oligocarbonate, tetrachlorobisphenol A oligocarbonate, pentabromopolyacrylate, brominated polystyrene and decabromodiphenyl ether. Examples of suitable organic phosphorus compounds are the phosphorus compounds according to WO-A 98/17720 (=U.S. Pat. No. 6,538,024), e.g. triphenyl phosphate (TPP), resorcinol bis(diphenyl phosphate) (RDP) and the oligomers derived therefrom, and also bisphenol A bis(diphenyl phosphate) (BDP) and the oligomers derived therefrom, and moreover organic and inorganic phosphonic acid derivatives and their salts, organic and inorganic phosphinic acid derivatives and their salts, in particular metal dialkylphosphinates, such as aluminum tris[dialkylphosphinates] or zinc bis[dialkylphosphinates], and moreover red phosphorus, phosphites, hypophosphites, phosphine oxides, phosphazenes, melamine pyrophosphate and mixtures of these. Nitrogen compounds that can be used are those from the group of the allantoin derivatives, cyanuric acid derivatives, dicyandiamide derivatives, glycoluril derivatives, guanidine derivatives, ammonium derivatives and melamine derivatives, preferably allantoin, benzoguanamine, glycoluril, melamine, condensates of melamine, e.g. melem, melam or melom, or compounds of this type having higher condensation level and adducts of melamine with acids, e.g. with cyanuric acid (melamine cyanurate), with phosphoric acid (melamine phosphate) or with condensed phosphoric acids (e.g. melamine polyphosphate). Examples of suitable synergists are antimony compounds, in particular antimony trioxide, sodium antimonate and antimony pentoxide, zinc compounds, e.g. zinc borate, zinc oxide, zinc phosphate and zinc sulfide, tin compounds, e.g. tin stannate and tin borate, and also magnesium compounds, e.g. magnesium oxide, magnesium carbonate and magnesium borate. Materials known as carbonizers can also be added to the flame retardant, examples being phenol-formaldehyde resins, polycarbonates, polyphenyl ethers, polyimides, polysulfones, polyether sulfones, polyphenylene sulfides, and polyether ketones, and also antidrip agents, such as tetrafluoroethylene polymers.

In another alternative preferred embodiment, the polymer molding compositions to be used for the production of the structural organosheet-components of the invention can also, if appropriate, comprise in addition to components A) and B) and C) and/or D), or instead of C) and/or D),
E) from 0.001 to 80 parts by weight, particularly preferably from 2 to 19 parts by weight, with particular preference from 9 to 15 parts by weight, of at least one elastomer modifier.

The elastomer modifiers to be used as component E) comprise one or more graft polymers of
E.1 from 5 to 95% by weight, preferably from 30 to 90% by weight, of at least one vinyl monomer on
E.2 from 95 to 5% by weight, preferably from 70 to 10% by weight, of one or more graft bases whose glass transition temperatures are <10° C., preferably <0° C., particularly preferably <−20° C.

The average particle size (d₅₀ value) of the graft base E.2 is generally from 0.05 to 10 μm, preferably from 0.1 to 5 μm, particularly preferably from 0.2 to 1 μm.

Monomers E.1 are preferably mixtures composed of
E.1.1 from 50 to 99% by weight of vinylaromatics and/or ring-substituted vinylaromatics (such as styrene, α-methylstyrene, p-methylstyrene, p-chlorostyrene) and/or (C₁-C₈)-alkyl methacrylates (e.g. methyl methacrylate, ethyl methacrylate) and
E.1.2 from 1 to 50% by weight of vinyl cyanides (unsaturated nitriles, such as acrylonitrile and methacrylonitrile) and/or (C₁-C₈)-alkyl(meth)acrylates (e.g. methyl methacrylate, n-butyl acrylate, tert-butyl acrylate) and/or derivatives (such as anhydrides and imides) of unsaturated carboxylic acids (e.g. maleic anhydride and N-phenylmaleimide).

Preferred monomers E.1.1 have been selected from at least one of the monomers styrene, α-methylstyrene and methyl methacrylate, and preferred monomers E.1.2 have been selected from at least one of the monomers acrylonitrile, maleic anhydride and methyl methacrylate.

Particularly preferred monomers are E.1.1 styrene and E.1.2 acrylonitrile.

Examples of suitable graft bases E.2 for the graft polymers to be used in the elastomer modifiers E) are diene rubbers, EP(D)M rubbers, i.e. rubbers based on ethylene/propylene and, if appropriate, diene, acrylate rubbers, polyurethane rubbers, silicone rubbers, chloroprene rubbers and ethylene-vinyl acetate rubbers.

Preferred graft bases E.2 are diene rubbers (e.g. based on butadiene, isoprene, etc.) or mixtures of diene rubbers, or are copolymers of diene rubbers or of their mixtures with further copolymerizable monomers (e.g. according to E.1.1 and E.1.2), with the proviso that the glass transition temperature of component E.2 is <10° C., preferably <0° C., particularly preferably <−10° C.

Examples of particularly preferred graft bases E.2 are ABS polymers (emulsion, bulk and suspension ABS), as described by way of example in DE-A 2 035 390 (=U.S. Pat. No. 3,644,574) or in DE-A 2 248 242 (=GB-A 1 409 275) or in Ullmann, Enzyklopadie der Technischen Chemie [Encyclopaedia of Industrial Chemistry], Vol. 19 (1980), pp. 280 et seq. The gel content of the graft base E.2 is preferably at least 30% by weight, particularly preferably at least 40% by weight (measured in toluene).

The elastomer modifiers or graft polymers E) are prepared via free-radical polymerization, e.g. via emulsion, suspension, solution or bulk polymerization, preferably via emulsion or bulk polymerization.

Other particularly suitable graft rubbers are ABS polymers which are prepared via redox initiation using an initiator system composed of organic hydroperoxide and ascorbic acid according to U.S. Pat. No. 4,937,285.

Because it is known that the graft monomers are not necessarily entirely grafted onto the graft base during the grafting reaction, products which are obtained via (co)polymerization of the graft monomers in the presence of the graft base and are produced concomitantly during the work-up are also graft polymers E) according to the invention.

Suitable acrylate rubbers are based on graft bases E.2 which are preferably polymers composed of alkyl acrylates, if appropriate with up to 40% by weight, based on E.2, of other polymerizable, ethylenically unsaturated monomers. Among the preferred polymerizable acrylic esters are C₁-C₈-alkyl esters, such as methyl, ethyl, butyl, n-octyl and 2-ethylhexyl esters; haloalkyl esters, preferably halo-C₁-C₈-alkyl esters, such as chloroethyl acrylate, and also mixtures of these monomers.

For crosslinking, monomers having more than one polymerizable double bond can be copolymerized. Preferred examples of crosslinking monomers are esters of unsaturated monocarboxylic acids having from 3 to 8 carbon atoms and esters of unsaturated monohydric alcohols having from 3 to 12 carbon atoms, or of saturated polyols having from 2 to 4 OH groups and from 2 to 20 carbon atoms, e.g. ethylene glycol dimethacrylate, allyl methacrylate; polyunsaturated heterocyclic compounds, e.g. trivinyl and triallyl cyanurate; polyfunctional vinyl compounds, such as di- and trivinylbenzenes; and also triallyl phosphate and diallyl phthalate.

Preferred crosslinking monomers are allyl methacrylate, ethylene glycol dimethacrylate, diallyl phthalate and heterocyclic compounds which have at least 3 ethylenically unsaturated groups.

Particularly preferred crosslinking monomers are the cyclic monomers triallyl cyanurate, triallyl isocyanurate, triacryloylhexahydro-s-triazine, and triallylbenzenes. The amount of the crosslinked monomers is preferably from 0.02 to 5% by weight, in particular from 0.05 to 2% by weight, based on the graft base E.2.

In the case of cyclic crosslinking monomers having at least 3 ethylenically unsaturated groups, it is advantageous to restrict the amount to below 1% by weight of the graft base E.2.

Examples of preferred “other” polymerizable, ethylenically unsaturated monomers which can serve alongside the acrylic esters, if appropriate, for preparation of the graft base E.2 are acrylonitrile, styrene, α-methylstyrene, acrylamides, vinyl C₁-C₆-alkyl ethers, methyl methacrylate, butadiene. Acrylate rubbers preferred as graft base E.2 are emulsion polymers whose gel content is at least 60% by weight.

Further suitable graft bases according to E.2 are silicone rubbers having sites active for grafting purposes, as described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

Alongside elastomer modifiers based on graft polymers, it is also possible to use, as component E), elastomer modifiers not based on graft polymers but having glass transition temperatures <10° C., preferably <0° C., particularly preferably <−20° C. Among these can be, by way of example, elastomers with block copolymer structure. Among these can also be, by way of example, elastomers which can undergo thermoplastic melting. Preferred materials mentioned here by way of example are EPM rubbers, EPDM rubbers and/or SEBS rubbers.

In another alternative preferred embodiment, the polymer molding compositions to be used for the production of the structural organosheet-components of the invention can also, if appropriate, comprise in addition to components A) and B) and C) and/or D) and/or E), or instead of C), D), or E),
F) from 0.001 to 10 parts by weight, preferably from 0.05 to 3 parts by weight, particularly preferably from 0.1 to 0.9 part by weight, of further conventional additives.

For the purposes of the present invention, examples of conventional additives are stabilizers (e.g. UV stabilizers, heat stabilizers, gamma-ray stabilizers), antistatic agents, flow aids, mold-release agents, further fire-protection additives, emulsifiers, nucleating agents, plasticizers, lubricants, dyes, pigments and additives for increasing electrical conductivity. The additives mentioned and further suitable additives are described by way of example in Gächter, Müller, Kunststoff-Additive [Plastics Additives], 3rd Edition, Hanser-Verlag, Munich, Vienna, 1989 and in Plastics Additives Handbook, 5th Edition, Hanser-Verlag, Munich, 2001. The additives may be used alone or in a mixture, or in the form of masterbatches.

Preferred stabilizers used are sterically hindered phenols, hydroquinones, aromatic secondary amines, e.g. diphenylamines, substituted resorcinols, salicylates, benzotriazoles and benzophenones, and also various substituted representatives of these groups and mixtures thereof.

Preferred pigments and dyes used are titanium dioxide, zinc sulfide, ultramarine blue, iron oxide, carbon black, phthalocyanines, quinacridones, perylenes, nigrosin and anthraquinones.

Preferred nucleating agents used are sodium phenylphosphinate or calcium phenylphosphinate, aluminum oxide, silicon dioxide, and also talc, particularly preferably talc.

Preferred lubricants and mold-release agents used are ester waxes, pentaerythritol tetrastearate (PETS), long-chain fatty acids (e.g. stearic acid or behenic acid) and fatty acid esters, salts thereof (e.g. Ca stearate or Zn stearate), and also amide derivatives (e.g. ethylenebisstearylamide) or montan waxes (mixtures composed of straight-chain, saturated carboxylic acids having chain lengths of from 28 to 32 carbon atoms), and also low-molecular-weight polyethylene waxes and polypropylene waxes.

Preferred plasticizers used are dioctyl phthalate, dibenzyl phthalate, butyl benzyl phthalate, hydrocarbon oils, N-(n-butyl)benzenesulfonamide.

Preferred additives which can be added to increase electrical conductivity are carbon blacks, conductivity blacks, carbon fibrils, nanoscale graphite fibers and carbon fibers, graphite, conductive polymers, metal fibers, and also other conventional additives for increasing electrical conductivity. Nanoscale fibers which can preferably be used are those known as “single-wall carbon nanotubes” or “multiwall carbon nanotubes” (e.g. from Hyperion Catalysis).

In another alternative preferred embodiment, the polyamide molding compositions can also, if appropriate, comprise in addition to components A) and B) and C), and/or D), and/or E), and/or F), or instead of C), D), E), or F),
G) from 0.5 to 30 parts by weight, preferably from 1 to 20 parts by weight, particularly preferably from 2 to 10 parts by weight and most preferably from 3 to 7 parts by weight, of compatibilizer.

Compatibilizers used preferably comprise thermoplastic polymers having polar groups.

According to the invention, polymers used are therefore those which contain
G.1 a vinylaromatic monomer,
G.2 at least one monomer selected from the group of C₂-C₁₂-alkyl methacrylates, C₂-C₁₂-alkyl acrylates, methacrylonitriles and acrylonitriles and
G.3 dicarboxylic anhydrides containing α,β-unsaturated components.

The component G.1, G.2 and G.3 used preferably comprises terpolymers of the monomers mentioned. Accordingly, it is preferable to use terpolymers of styrene, acrylonitrile and maleic anhydride. In particular, these terpolymers contribute to improvement in mechanical properties, such as tensile strength and tensile strain at break. The amount of maleic anhydride in the terpolymer can vary widely. The amount is preferably from 0.2 to 5 mol %. Amounts of from 0.5 to 1.5 mol % are particularly preferred. In this range, particularly good mechanical properties are achieved in relation to tensile strength and tensile strain at break.

The terpolymer can be prepared in a known manner. One suitable method is to dissolve monomer components of the terpolymer, e.g. styrene, maleic anhydride or acrylonitrile, in a suitable solvent, e.g. methyl ethyl ketone (MEK). One or, if appropriate, more chemical initiators are added to this solution. Preferred initiators are peroxides. The mixture is then polymerized at elevated temperatures for a number of hours. The solvent and the unreacted monomers are then removed in a manner known per se.

The ratio of component G.1 (vinylaromatic monomer) to component G.2, e.g. the acrylonitrile monomer in the terpolymer is preferably from 80:20 to 50:50.

Styrene is particularly preferred as vinylaromatic monomer G.1. Acrylonitrile is particularly preferably suitable for component G.2. Maleic anhydride is particularly preferably suitable as component G.3.

EP-A 0 785 234 (=U.S. Pat. No. 5,756,576) and EP-A 0 202 214 (=U.S. Pat. No. 4,713,415) describe examples of compatibilizers G) which can be used according to the invention. According to the invention, particular preference is given to the polymers mentioned in EP-A 0 785 234.

The compatibilizers can be present in component G) alone or in any desired mixture with one another.

Another substance particularly preferred as compatibilizer is a terpolymer of styrene and acyrlonitrile in a ratio of 2.1:1 by weight containing 1 mol % of maleic anhydride.

Component G) is used particularly when the molding composition comprises graft polymers, as described under E).

According to the invention, the following combinations of the components are preferred in polymer molding compositions for use in hybrid-based lightweight components:

A,B; A,B,C; A,B,D; A,B,E; A,B,F; A,B,G; A,B,C,D; A,B,C,E; A,B,C,F; A,B,C,G; A,B,D,E; A,B,D,F; A,B,D,G; A,B,E,F; A,B,E,G; A,B,F,G; A,B,C,D,E; A,B,C,D,G; A,B,C,F,G; A,B,E,F,G; A,B,D,F,G; A,B,C,D,E,F; A,B,C,D,E,G; A,B,D,E,F,G; A,B,C,E,F,G; A,B,C,D,E,G; A,B,C,D,E,F,G.

The lightweight components which are based on a structural organosheet-component and which are to be produced in the invention from the polymer molding compositions used feature an exceptionally secure bond between the parent organosheet body and the thermoplastic. They also have high impact resistance and unusually high modulus of elasticity of about 19 000 MPa at room temperature. If polyamide is used in combination for example with a component B1), the content of glass fibers can be doubled from 30% by weight to 60% by weight, and this leads to doubled stiffness of a lightweight component which is produced therefrom and which is based on a structural organosheet-component. Surprisingly, the density of the polymer molding composition increases here only by about 15-20%. This can give a marked reduction in the wall thicknesses of the component parts for the same mechanical performance, with markedly reduced manufacturing costs. Motor vehicle front ends, a standard application of hybrid technology, can thus be constructed with lower weight and/or greater stiffness, and this is attended by a reduction of from 30 to 40% in weight and in manufacturing costs, in comparison with a component manufactured conventionally.

Lightweight components to be produced according to the invention and based on a structural organosheet-component of the invention using improved-flow molding compositions, where, in the event of use of a parent body in the shape of a shell, the external or internal space thereof has reinforcing structures, preferably in rib form, which have been securely bonded to the parent body and which are composed of molded-on thermoplastic, and the bonding of these to the parent body is achieved at discrete connection sites via perforations in the parent body, can therefore be used in the following sectors: shipbuilding, aircraft construction, automotive and non-automotive, preferably in the form of vehicle parts (automotive sector), and in load-bearing elements of office machinery, of household machinery, or of other machinery, or in design elements for decorative purposes, staircases, escalator steps, or manhole covers.

It is preferable that they are used in motor vehicles as roof structures, composed by way of example of roof frames, roof arch and/or rooftop elements, or for column structures, e.g. A-, B- and/or C-column, for chassis structures, composed by way of example of steering stub, coupling rod, wishbone and/or stabilizers, or for longitudinal-member structures, for example composed of longitudinal member and/or sill, or for front-end structures, for example composed of front ends, front-end module, headlamp frame, lock member, transverse member, radiator member and/or assembly support, or for pedal structures, for example composed of brake pedal, accelerator pedal and clutch pedal, pedal block and/or pedal module, or for door structures and flap structures, for example front and rear driver and passenger doors, tailgates and/or engine hood, or for instrument-panel-support structures, for example composed of transverse member, instrument-panel member and/or cockpit member, for oil pans, for example transmission-oil pans, and/or oil modules, or for seat structures, for example composed of seat-backrest structure, backrest structure, seat-pan structure, belt cross-tie and/or armrest, or in the form of complete front ends, pedestrian-protection beam, specific slam panels for engine hoods or luggage-compartment lids, front roof arch, rear roof arch, roof frame, roof modules (entire roof), sliding-roof-support parts, dashboard-support parts (cross car beam), steering-column retainers, firewall, pedals, pedal blocks, gear-shift blocks, A-columns, B-columns, C-columns, B-column modules, longitudinal members, jointing elements for the connection of longitudinal members and B-columns, jointing elements for the connection of A-column and transverse member, jointing elements for the connection of A-column, transverse member and longitudinal member, transverse members, wheel surrounds, wheel-surround modules, crash boxes, rear ends, spare-wheel recesses, engine hoods, engine covers, water-tank assembly, engine-rigidity systems (front-end rigidity system), vehicle floor, floor-rigidity systems, seat-rigidity system, transverse seat members, tailgates, vehicle frames, seat structures, backrests, seat shells, seat backrests with or without integrated safety belt, parcel shelves, valve cover, end-shields for generators or electric motors, complete vehicle-door structures, side-impact members, module members, oil pans, -oil pans, transmission-oil modules, headlamp frames, sills, sill reinforcement systems, chassis components, and motor-scooter frames.

Preferred use of the lightweight components of the invention, based on a structural organosheet-component using improved-flow molding compositions in the non-automotive sector is in electrical and electronic equipment, household equipment, furniture, heaters, shopping trollies, shelving, staircases, escalator steps, and manhole covers.

However, the lightweight components of the invention, based on a structural organosheet-component, using improved-flow molding compositions, are of course also suitable for use in rail vehicles, aircraft, ships, sleds, motor scooters, or other means of conveyance, where it is important that designs have low weight but are nevertheless stable.

The molding compositions of the invention can be processed by conventional shaping processes, for example by injection molding or extrusion, to give the structural organosheet-components of the invention. Processing by injection molding is particularly preferred.

The present invention therefore also provides a process for the production of a structural organosheet-component with a parent body which is composed of organosheet having reinforcing structures, where the reinforcing structures have been securely bonded to the parent organosheet body and are composed of molded-on polymer, which comprises using, as backing material, polymer molding compositions comprising
A) from 99.99 to 10 parts by weight, more preferably from 99.5 to 40 parts by weight, particularly preferably from 99.0 to 55 parts by weight, of thermoplastic, and
B) from 0.01 to 50 parts by weight, preferably from 0.25 to 20 parts by weight, particularly preferably from 1.0 to 15 parts by weight, of a flow improver, and the flow improver used is at least one component from the group of B1), B2), B3), and B4), in which
B1) is a copolymer composed of at least one olefin, preferably α-olefin, and of at least one methacrylate or acrylate of an aliphatic alcohol, preferably of an aliphatic alcohol having from 1 to 30 carbon atoms, where the MFI (melt flow index) thereof is not less than 100 g/10 min, and the MFI is measured or determined at 190° C., using a load of 2.16 kg,
B2) is a highly branched or hyperbranched polycarbonate with an OH number of from 1 to 600 mg KOH/g of polycarbonate (to DIN 53240, Part 2),
B3) is a highly branched or hyperbranched polyester of AₓB_{y} type, where x is at least 1.1 and y is at least 2.1, and
B4) is a low-molecular-weight polyalkylene glycol ester (PAGE) of the general formula (I)

R—COO—(Z—O)ₙOC—R (I)
in which
R is a branched or straight-chain alkyl group having from 1 to 20 carbon atoms,
Z is a branched or straight-chain C₂-C₁₅-alkylene group, and
n is a whole number from 2 to 20, or comprises using, as thermoplastic in conventional shaping processes, preferably injection-molding processes or extrusion processes, polyamides having macromolecular chains having a star-shaped structure and having linear, macromolecular chains.

However, the present invention also provides a process for reducing the weight of components, preferably of motor vehicles, aircraft, or ships of any type, which comprises using lightweight components based on a structural organosheet-component with use of improved-flow molding compositions with a parent body which is composed of organosheet and which has reinforcing structures, where the reinforcing structures have been securely bonded to the parent body and are composed of molded-on polymer, and using polymer molding compositions comprising
A) from 99.99 to 10 parts by weight, more preferably from 99.5 to 40 parts by weight, particularly preferably from 99.0 to 55 parts by weight, of thermoplastic, and
B) from 0.01 to 50 parts by weight, preferably from 0.25 to 20 parts by weight, particularly preferably from 1.0 to 15 parts by weight, of a flow improver, and the flow improver used is at least one component from the group of B1), B2), B3), and B4), in which
B1) is a copolymer composed of at least one olefin, preferably α-olefin, and of at least one methacrylate or acrylate of an aliphatic alcohol, preferably of an aliphatic alcohol having from 1 to 30 carbon atoms, where the MFI (melt flow index) thereof is not less than 100 g/10 min, and the MFI is measured or determined at 190° C., using a load of 2.16 kg,
B2) is a highly branched or hyperbranched polycarbonate with an OH number of from 1 to 600 mg KOH/g of polycarbonate (to DIN 53240, Part 2),
B3) is a highly branched or hyperbranched polyester of AₓB_{y} type, where x is at least 1.1 and y is at least 2.1, and
B4) is a low-molecular-weight polyalkylene glycol ester (PAGE) of the general formula (I)

R—COO—(Z—O)ₙOC—R (I)
in which
R is a branched or straight-chain alkyl group having from 1 to 20 carbon atoms,
Z is a branched or straight-chain C₂-C₁₅-alkylene group, and
n is a whole number from 2 to 20.

For the purposes of the present invention, a secure interlock bond means that the extruded polymer enters into a secure bond with the parent organosheet body by way of microstructures in the surface of that body. According to EP-A 0 370 342, a secure interlock bond is the opposite of a loose interlock bond, meaning that there is no play. The term interlock bond itself means that the cross section providing the interlock bond has to be disrupted under load before the bonded subsections, in this case parent organosheet body and thermoplastic, can be separated from one another.

In one preferred embodiment, this interlock bond is also promoted or enhanced by openings in the parent body, in that the thermoplastic is forced through these and flows out on the opposite side of the openings by way of the edges of the openings, thus giving a secure interlock bond on solidification. In one particularly preferred embodiment it is also possible, however, that the flash material protruding by way of the openings is subjected to mechanical working with a tool in an additional operation, in such a way as to provide further enhancement of the interlock bond. In another meaning of the term “securely bonded”, (an) item(s) is/are subsequently bonded in place by use of adhesives or by use of a laser. However, it is also possible to achieve the secure interlock bond by a process involving flow around (processing a web around) the parent body.

However, the present invention also provides vehicles or other means of conveyance, particularly motor vehicles, rail vehicles, aircraft, ships, sleds, or motor scooters, comprising a lightweight component based on a structural organosheet-component with use of improved-flow molding compositions, wherein polymer molding compositions are used comprising
A) from 99.99 to 10 parts by weight, more preferably from 99.5 to 40 parts by weight, particularly preferably from 99.0 to 55 parts by weight, of thermoplastic, and
B) from 0.01 to 50 parts by weight, preferably from 0.25 to 20 parts by weight, particularly preferably from 1.0 to 15 parts by weight, of a flow improver from the group of B1), B2), B3), or B4), and
B1) is a copolymer composed of at least one olefin, preferably α-olefin, and of at least one methacrylate or acrylate of an aliphatic alcohol, preferably of an aliphatic alcohol having from 3 to 50 carbon atoms, where the MFI thereof is not less than 100 g/10 min, and the MFI (melt flow index) is measured or determined at 190° C., using a test weight of 2.16 kg,
B2) is a highly branched or hyperbranched polycarbonate with an OH number of from 1 to 600 mg KOH/g of polycarbonate (to DIN 53240, Part 2),
B3) is a highly branched or hyperbranched polyester of AₓB_{y} type, where x is at least 1.1 and y is at least 2.1, and
B4) is a low-molecular-weight polyalkylene glycol ester (PAGE) of the general formula (I)

R—COO—(Z—O)ₙOC—R (I)
in which
R is a branched or straight-chain alkyl group having from 1 to 20 carbon atoms,
Z is a branched or straight-chain C₂-C₁₅-alkylene group, and
n is a whole number from 2 to 20.

It will be understood that the specification and examples are illustrative but not limitative of the present invention and that other embodiments within the spirit and scope of the invention will suggest themselves to those skilled in the art.

1. A structural organosheet-component composed of polymer-overmolded organosheet, wherein the backing material used comprises polymer molding compositions comprising
A) from 99.99 to 10 parts by weight of thermoplastic, and
B) from 0.01 to 50 parts by weight of a flow improver selected from the group consisting of B1), B2), B3), and B4), and
B1) is a copolymer composed of at least one olefin, and of at least one methacrylate or acrylate of an aliphatic alcohol, where the MFI is not less than 100 g/10 min, and where the MFI (melt flow index) is measured or determined at 190° C., using a test weight of 2.16 kg,
B2) is a highly branched or hyperbranched polycarbonate with an OH number of from 1 to 600 mg KOH/g of polycarbonate (to DIN 53240, Part 2),
B3) is a highly branched or hyperbranched polyester of AₓB_{y} type, where x is at least 1.1 and y is at least 2.1, and
B4) is a low-molecular-weight polyalkylene glycol ester (PAGE) of the formula (I)
R—COO—(Z—O)ₙOC—R (I)
in which
R is a branched or straight-chain alkyl group having from 1 to 20 carbon atoms,
Z is a branched or straight-chain C₂-C₁₅-alkylene group, and
n is a whole number from 2 to 20,
or wherein, irrespective of the use of a component B), the thermoplastics used comprise polyamides having macromolecular chains with star-shaped structure and having linear macromolecular chains.

2. A structural organosheet-component as claimed in claim 1, wherein, in the case of the use of polyamides having macromolecular chains of star-shaped structure and having linear macromolecular chains, this material comprises a mixture of
a) monomers of the formula (II) R₁-(-D-Z)ₘ,
b) monomers of the formula ((IIIa) X—R₂—Y and 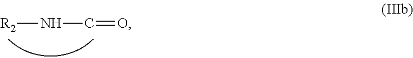
c) monomers of the formula (IV) Z—R₃—Z, in which
R₁ is a linear or cyclic, aromatic or aliphatic carbon radical having at least two carbon atoms and optionally comprises heteroatoms,
D is a covalent bond or an aliphatic hydrocarbon radical having from 1 to 6 carbon atoms,
Z is a primary amine radical or a carboxy group,
R₂ and R₃ are identical or different and are aliphatic, cycloaliphatic, or aromatic, substituted or unsubstituted hydrocarbon radicals which comprises from 2 to 20 carbon atoms and optionally comprises heteroatoms, and
Y is a primary amine radical if X is a carbonyl radical, or Y is a carbonyl radical if X is a primary amine radical, where m is a whole number from 3 to 8.

3. A structural organosheet-component as claimed in claim 1, wherein the secure interlock bond between molded-on thermoplastic and the organosheet is additionally achieved by way of discrete connection sites by way of perforations in the parent organosheet body, where the thermoplastic extends through these and across the area of the perforations.

4. A structural organosheet-component as claimed in claim 1, wherein the parent organosheet body has the shape of a shell.

5. A structural organosheet-component as claimed in claim 1, wherein molding compositions comprising components A) and B) and C) from 0.001 to 75 parts by weight of a filler or reinforcing material are used during production.

6. A structural organosheet-component as claimed in claim 5, comprising glass fibers as filler or as reinforcing material.

7. A process for the production of a structural organosheet-component with an organosheet having reinforcing structures, bonded to the parent body and being composed of molded-on polymer, which comprises using polymer molding compositions comprising
A) from 99.99 to 10 parts by weight of thermoplastic, and
B) from 0.01 to 50 parts by weight of a flow improver, wherein the flow improver is at least one component selected from the group consisting of B1), B2), B3), and B4), in which
B1) is a copolymer composed of at least one olefin and of at least one methacrylate or acrylate of an aliphatic alcohol, where the MFI (melt flow index) thereof is not less than 100 g/10 min, and the MFI is measured or determined at 190° C., using a load of 2.16 kg,
B2) is a highly branched or hyperbranched polycarbonate with an OH number of from 1 to 600 mg KOH/g of polycarbonate (to DIN 53240, Part 2),
B3) is a highly branched or hyperbranched polyester of AₓB_{y} type, where x is at least 1.1 and y is at least 2.1, and
B4) is a low-molecular-weight polyalkylene glycol ester (PAGE) of the formula (I)
R—COO—(Z—O)ₙOC—R (I)
in which
R is a branched or straight-chain alkyl group having from 1 to 20 carbon atoms,
Z is a branched or straight-chain C₂-C₁₅-alkylene group, and
n is a whole number from 2 to 20, or comprises using, as thermoplastic in injection-molding processes or extrusion processes, polyamides having macromolecular chains having a star-shaped structure and having linear, macromolecular chains.

8. A structural component for automotive or non-automotive applications, comprising the structural organosheet-components as claimed in claim 1.

9. A structural component according to claim 8, wherein the automotive sector and the non-automotive-sector are motor vehicles, rail vehicles, aircraft, ships, sleds or other means of conveyance, or electrical or electronic equipment, household equipment, furniture, heaters, motor scooters, shopping trolleys, shelving, staircases, escalator steps, or manhole covers.

10. Automotive roof structures, column structures, chassis structures, longitudinal-member structures, or front-end structures, front-end modules, headlamp frames, lock members, transverse members, radiator members and/or assembly supports, pedal structures, pedal block and/or pedal modules, door structures and flap structures, for instrument-panel-support structures, oil pans, seat structures, pedestrian-protection beams, specific slam panels for engine hoods, sliding-roof-support parts, dashboard-support parts (cross car beam), steering-column retainers, firewall, gear-shift blocks, B-column modules, jointing elements for the connection of longitudinal members and B-columns, and of transverse members, wheel surrounds, wheel-surround modules, crash boxes, rear ends, spare-wheel recesses, engine hoods, engine-oil pans, water-tank assemblies, engine-rigidity systems (front-end rigidity system), chassis components, vehicle floors, sills, sill-reinforcement systems, floor-regidity systems, seat-regidity system, transverse seat members, frames, seat shells, seat backrests with or without integrated safety belt, parcel shelves, complete vehicle-door structures, jointing elements for the connection of A-column and transverse members, jointing elements for the connection of A-column, transverse member, and floor-rigidity systems, transverse seat members, valve covers, end-shields for generators or electric motors comprising the structural organosheet-component of claim 1.
